(19) United States
(12) Patent Application Publication
(10) Pub. No.: US 2025/0135699 A1
(43) Pub. Date: May 1, 2025

(54) MONITORING DEVICE FOR INJECTION MOLDING MACHINE

(71) Applicant: SUMITOMO HEAVY INDUSTRIES, LTD., Tokyo (JP)

(72) Inventors: Takuya MIZUNASHI, Chiba (JP); Katsunobu HANO, Chiba (JP); Tomosuke KADOONO, Chiba (JP); Shoki MIYAZAKI, Chiba (JP)

(21) Appl. No.: 18/928,613

(22) Filed: Oct. 28, 2024

(30) Foreign Application Priority Data
Oct. 31, 2023 (JP) 2023-186605

(51) Int. Cl. B29C 45/76; B29C 45/77

(52) U.S. Cl. CPC B29C 45/768; B29C 45/77; B29C 2045/7606; B29C 2945/76006; B29C 2945/7612; B29C 2945/76949

(57) ABSTRACT

A monitoring device for an injection molding machine includes circuitry configured to acquire first data from a sensor provided in an injection molding machine, the first data indicating detection results in a time series; input the first data into a trained model and acquire a first value from the trained model, the first value representing an evaluation of a product, the trained model being trained by machine learning with training data, the training data combining second data and a second value, the second data indicating detection results from the sensor in a time series, and the second value representing an evaluation of the product produced by the injection molding machine; and determine whether an abnormality has occurred in the detection results of the sensor, based on the acquired first value by the inferring unit.

### CROSS-REFERENCE TO RELATED APPLICATIONS

This application is based upon and claims priority to Japanese Patent Application No. 2023-186605, filed on Oct. 31, 2023, the entire contents of which are incorporated herein by reference.

### BACKGROUND

### 1. Technical Field

The present disclosure relates to a monitoring device for an injection molding machine.

### 2. Description of Related Art

Conventionally, a monitoring function for checking whether a product is appropriately produced by an injection molding machine is provided. The monitoring function between molding shots includes a function to input a time to waveform data that shows the detection results of a sensor installed in an injection molding machine in a time series, thereby monitoring the detection results of the sensor at that time, and a function to monitor values derived from the waveform data by performing a calculation using one or more of the maximum, minimum, average, and integral. In either case, a person needs to perform setting for determining whether a product is appropriately produced while visually checking waveform data.

With the improvement of the processing capability of a computer, artificial intelligence tends to develop accordingly. For example, the related-art technique proposes a technique by machine learning for estimating whether a product produced is a non-defective product.

### SUMMARY

According to an aspect of the present disclosure, a monitoring device for an injection molding machine is provided. The monitoring device includes:
circuitry configured to
acquire first data from a sensor provided in an injection molding machine, the first data indicating detection results in a time series;
input the first data into a trained model and acquire a first value from the trained model, the first value representing an evaluation of a product, the trained model being trained by machine learning with training data, the training data combining second data and a second value, the second data indicating detection results from the sensor in a time series, and the second value representing an evaluation of the product produced by the injection molding machine; and
determine whether an abnormality has occurred in the detection results of the sensor, based on the acquired first value by the inferring unit.

### BRIEF DESCRIPTION OF THE DRAWINGS

FIG. 1 is a diagram illustrating a state when mold opening of an injection molding machine according to an embodiment is completed.

FIG. 2 is a diagram illustrating a state when a mold of the injection molding machine according to the embodiment is clamped.

FIG. 3 is a diagram illustrating an example of a functional configuration of a control device according to an embodiment.

FIG. 4 is a diagram illustrating a structure of a trained model used in the control device according to the embodiment.

FIG. 5 is a conceptual diagram illustrating the structure of the trained model according to the embodiment.

FIG. 6 is a diagram illustrating a log information screen displayed by a display control unit according to the embodiment.

FIG. 7 is a diagram illustrating a monitoring setting screen displayed by the display control unit according to the embodiment;

FIG. 8 is a diagram illustrating an operation setting screen displayed by the display control unit according to the embodiment when a defect is detected.

FIG. 9 is a diagram illustrating quality characteristics output from the trained model according to the embodiment.

FIG. 10 is a diagram illustrating waveform data for each (shot) number, which is detected when a molded product is molded by the injection molding machine according to the embodiment.

FIG. 11 is a diagram illustrating waveform data for each (shot) number, which is detected when a molded product is molded by the injection molding machine according to the embodiment.

FIG. 12 is a conceptual diagram illustrating linkage related to a trained model by a learning device and a control device of an injection molding machine according to another embodiment.

FIG. 13 is a conceptual diagram illustrating a structure of the trained model according to another embodiment.

FIG. 14 is a diagram illustrating an example of a functional configuration of the learning device and the control device according to another embodiment.

### DETAILED DESCRIPTION

However, in the technique described in the related-art technique, in order to estimate whether a product is a non-defective product, it is necessary to perform machine learning again when determination criteria are changed. In other words, it is difficult to provide flexibility in the evaluation of the product.

One aspect of the present disclosure provides a technique that allows for flexibility in abnormality determination.

According to one aspect of the present disclosure, the accuracy in determining abnormalities is improved by providing flexibility in abnormality determination.

Hereinafter, embodiments of the present disclosure will be described with reference to the accompanying drawings. The embodiments described below are not intended to limit the invention but are merely examples, and all features and combinations thereof described in the embodiments are not necessarily essential to the invention. In the drawings, the same or corresponding components are denoted by the same or corresponding reference numerals, and the description thereof may be omitted.

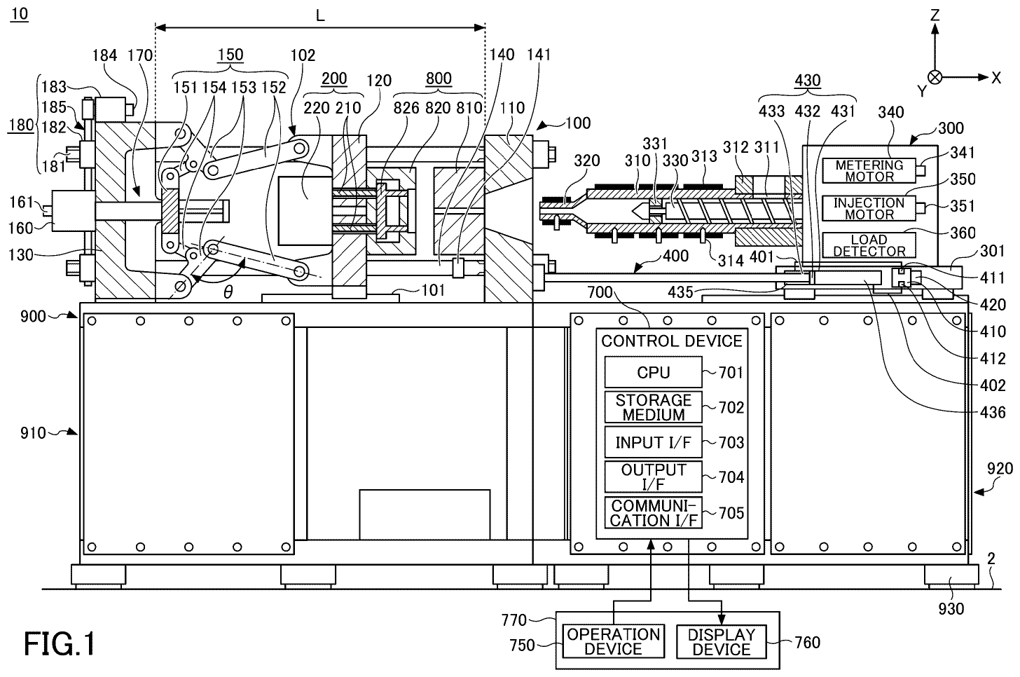

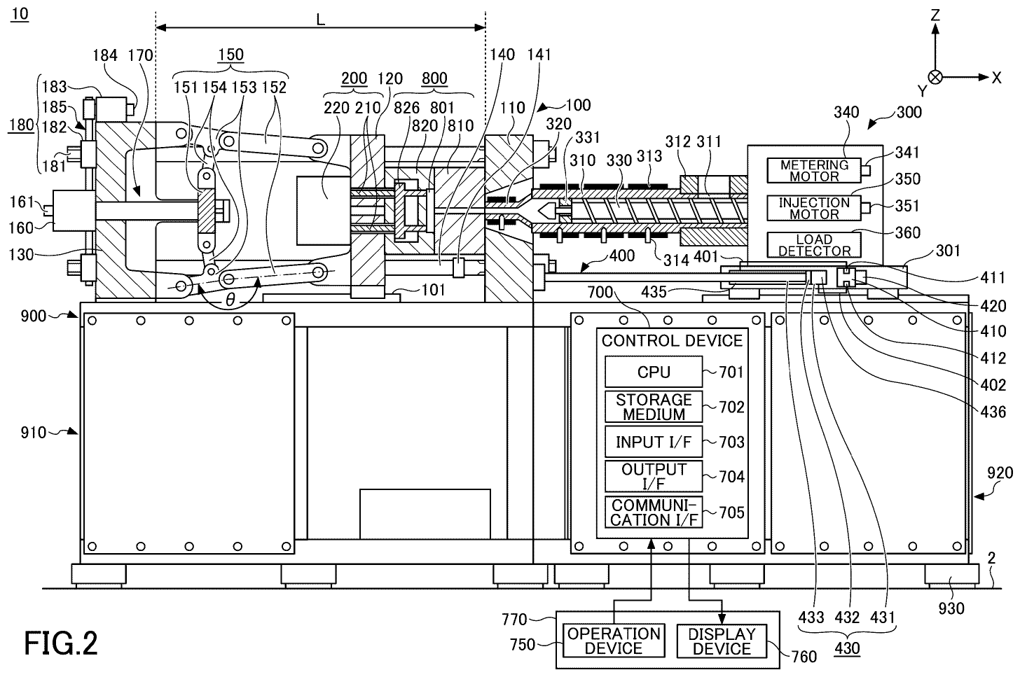

FIG. 1 is a diagram illustrating a state when mold opening of an injection molding machine according to an embodiment is completed. FIG. 2 is a diagram illustrating a state when a mold of the injection molding machine according to the embodiment is clamped. In the present specification, an X-axis direction, a Y-axis direction, and a Z-axis direction are directions perpendicular to each other. The X-axis direction and the Y-axis direction represent a horizontal direction, and the Z-axis direction represents a vertical direction. When a mold clamping device 100 is a horizontal type, the X-axis direction is a mold opening-closing direction, and the Y-axis direction is a width direction of an injection molding machine 10. A negative side in the Y-axis direction is called an operating side, and a positive side in the Y-axis direction is called an anti-operating side.

As illustrated in FIGS. 1 and 2, the injection molding machine 10 includes the mold clamping device 100 that opens and closes a mold device 800, an ejector device 200 that ejects a molded product molded by the mold device 800, an injection device 300 that injects a molding material into the mold device 800, a moving device 400 that advances and retracts the injection device 300 with respect to the mold device 800, a control device 700 that controls each component of the injection molding machine 10, and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are installed on the floor 2 via and, respective leveling adjusters 930. The control device 700 is disposed in an internal space of the injection device frame 920. Hereinafter, each component of the injection molding machine 10 will be described.

### (Clamping Device)

In the description of the mold clamping device 100, a moving direction (for example, an X-axis positive direction) of a movable platen 120 when the mold is closed is referred to as a front side, and a moving direction (for example, an X-axis negative direction) of the movable platen 120 when the mold is opened is referred to as a rear side.

The mold clamping device 100 performs closing, pressurizing, clamping, depressurizing, and opening of the mold device 800. The mold device 800 includes a fixed mold 810 and a movable mold 820. The mold clamping device 100 is, for example, a horizontal type, and the mold opening-closing direction is a horizontal direction. The mold clamping device 100 includes a stationary platen 110 to which the fixed mold 810 is attached, a movable platen 120 to which the movable mold 820 is attached, and a moving mechanism 102 that moves the movable platen 120 in the mold opening-closing direction with respect to the stationary platen 110.

The stationary platen 110 is fixed to the mold clamping device frame 910. The fixed mold 810 is attached to a surface of the stationary platen 110 facing the movable platen 120.

The movable platen 120 is disposed so as to be movable in the mold opening-closing direction with respect to the mold clamping device frame 910. A guide 101 for guiding the movable platen 120 is laid on the mold clamping device frame 910. A movable mold 820 is attached to a surface of the movable platen 120 facing the stationary platen 110.

The moving mechanism 102 advances and retracts the movable platen 120 with respect to the stationary platen 110 to perform closing, pressurizing, clamping, depressurizing, and opening of the mold device 800. The moving mechanism 102 includes a toggle support 130 disposed at a distance from the stationary platen 110, a tie bar 140 connecting the stationary platen 110 and the toggle support 130, a toggle mechanism 150 moving the movable platen 120 in the mold opening-closing direction with respect to the toggle support 130, a mold clamping motor 160 operating the toggle mechanism 150, a motion conversion mechanism 170 converting the rotational motion of the mold clamping motor 160 into linear motion, and a mold thickness adjustment mechanism 180 adjusting the distance between the stationary platen 110 and the toggle support 130.

The toggle support 130 is disposed with a space from the stationary platen 110 and is placed on the mold clamping device frame 910 so as to be movable in the mold opening-closing direction. The toggle support 130 may be disposed so as to be movable along a guide laid on the mold clamping device frame 910. The guide of the toggle support 130 may be common to the guide 101 of the movable platen 120.

In the present embodiment, the stationary platen 110 is fixed to the mold clamping device frame 910, and the toggle support 130 is disposed so as to be movable in the mold opening-closing direction with respect to the mold clamping device frame 910, but the toggle support 130 may be fixed to the mold clamping device frame 910, and the stationary platen 110 may be disposed so as to be movable in the mold opening-closing direction with respect to the mold clamping device frame 910.

The tie bar 140 connects the stationary platen 110 and the toggle support 130 with a space L in the mold opening-closing direction. A plurality of (for example, four) tie bars 140 may be used. The plurality of tie bars 140 are arranged in parallel in the mold opening-closing direction and extend according to the mold clamping force. A tie bar strain detector 141 for detecting strain of the tie bar 140 may be provided on at least one tie bar 140. The tie bar strain detector 141 sends a signal indicating the detection result to the control device 700. The detection result of the tie bar strain detector 141 is used for detection of the mold clamping force and the like.

In the present embodiment, the tie bar strain detector 141 is used as a mold clamping force detector that detects the mold clamping force, but the present disclosure is not limited thereto. The mold clamping force detector is not limited to a strain gauge type, and may be a piezoelectric type, a capacitance type, a hydraulic type, an electromagnetic type, or the like, and the attachment position thereof is not limited to the tie bar 140.

The toggle mechanism 150 is disposed between the movable platen 120 and the toggle support 130, and moves the movable platen 120 in the mold opening-closing direction with respect to the toggle support 130. The toggle mechanism 150 includes a crosshead 151 that moves in the mold opening-closing direction, and a pair of link groups that bend and extend by the movement of the crosshead 151. The pair of link groups each include a first link 152 and a second link 153 which are connected to each other by a pin or the like so as to be bendable and extendable. The first link 152 is attached to the movable platen 120 by a pin or the like so as to be swingable. The second link 153 is swingably attached to the toggle support 130 by a pin or the like. The second link 153 is attached to the crosshead 151 via a third link 154. When the crosshead 151 advances and retracts with respect to the toggle support 130, the first link 152 and the second link 153 are bent and extended, and the movable platen 120 advances and retracts with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. The mold clamping motor 160 advances and retracts the crosshead 151 with respect to the toggle support 130 to bend and extend the first link 152 and the second link 153, and advances and retracts the movable platen 120 with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts the rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing step, a pressurizing step, a mold clamping step, a depressurizing step, a mold opening step, and the like under the control of the control device 700.

In the mold closing step, the mold clamping motor 160 is driven to advance the crosshead 151 to a mold closing completion position at a set movement speed, thereby advancing the movable platen 120 and causing the movable mold 820 to touch the fixed mold 810. The position and the moving speed of the crosshead 151 are detected by using, for example, a mold clamping motor encoder 161. The mold clamping motor encoder 161 detects the rotation of the mold clamping motor 160 and sends a signal indicating the detection result to the control device 700.

The crosshead position detector that detects the position of the crosshead 151 and the crosshead movement speed detector that detects the movement speed of the crosshead 151 are not limited to the mold clamping motor encoder 161, and general detectors may be used. Further, the movable platen position detector for detecting the position of the movable platen 120 and the movable platen moving speed detector for detecting the moving speed of the movable platen 120 are not limited to the mold clamping motor encoder 161, and general detectors can be used.

In the pressurizing step, the mold clamping force is generated by further driving the mold clamping motor 160 to further advance the crosshead 151 from the mold closing completion position to the mold clamping position.

In the mold clamping step, the mold clamping motor 160 is driven to maintain the position of the crosshead 151 at the mold clamping position. In the mold clamping step, the mold clamping force generated in the pressurizing step is maintained. In the mold clamping step, a cavity space 801 (see FIG. 2) is formed between the movable mold 820 and the fixed mold 810, and the injection device 300 fills the cavity space 801 with a liquid molding material. The filled molding material is solidified to obtain a molded product.

The number of cavity spaces 801 may be one or more. In the latter case, a plurality of molded products are obtained simultaneously. An insert material may be disposed in a part of the cavity space 801, and a molding material may be filled in another part of the cavity space 801. A molded product in which the insert material and the molding material are integrated is obtained.

In the depressurizing step, the movable platen 120 is retracted by driving the mold clamping motor 160 to retract the crosshead 151 from the mold clamping position to the mold opening start position, and the mold clamping force is reduced. The mold opening start position and the mold closing completion position may be the same position.

In the mold opening step, the movable platen 120 is retracted by driving the mold clamping motor 160 to retract the crosshead 151 from the mold opening start position to the mold opening completion position at a set movement speed, and the movable mold 820 is separated from the fixed mold 810. Thereafter, the ejector device 200 ejects the molded product from the movable mold 820.

The setting conditions in the mold closing step, the pressurizing step, and the mold clamping step are collectively set as a series of setting conditions. For example, the movement speed and position (including the mold closing start position, movement speed switching position, mold closing completion position, and mold clamping position) of the crosshead 151 in the mold closing step and the pressurizing step, and the mold clamping force are collectively set as a series of setting conditions. The mold closing start position, the moving speed switching position, the mold closing completion position, and the mold clamping position are arranged in this order from the rear side to the front side, and represent a start point and an end point of a section in which the moving speed is set. A moving speed is set for each section. The number of the moving speed switching positions may be one or more. The moving speed switching position may not be set. Only one of the mold clamping position and the mold clamping force may be set.

The setting conditions in the depressurizing step and the mold opening step are set in the same manner. For example, the movement speed and the position (the mold opening start position, the movement speed switching position, and the mold opening completion position) of the crosshead 151 in the depressurizing step and the mold opening step are collectively set as a series of setting conditions. The mold opening start position, the movement speed switching position, and the mold opening completion position are arranged in this order from the front side to the rear side, and represent a start point and an end point of a section in which the movement speed is set. A moving speed is set for each section. The number of the moving speed switching positions may be one or more. The moving speed switching position may not be set. The mold opening start position and the mold closing completion position may be the same position. The mold opening completion position and the mold closing start position may be the same position.

Instead of the moving speed and the position of the crosshead 151, the moving speed and the position of the movable platen 120 may be set. Further, instead of the position of the crosshead (for example, the mold clamping position) or the position of the movable platen, the mold clamping force may be set.

The toggle mechanism 150 amplifies the driving force of the mold clamping motor 160 and transmits the amplified driving force to the movable platen 120. The amplification factor is also called a toggle factor. The toggle magnification changes according to an angle θ formed by the first link 152 and the second link 153 (hereinafter, also referred to as a “link angle θ”). The link angle θ is obtained from the position of the crosshead 151. When the link angle θ is 180°, the toggle magnification is the largest.

When the thickness of the mold device 800 changes due to the replacement of the mold device 800 or a change in the temperature of the mold device 800, the mold thickness is adjusted so that a predetermined mold clamping force is obtained when the mold is clamped. In the mold thickness adjustment, for example, the space L between the stationary platen 110 and the toggle support 130 is adjusted so that the link angle θ of the toggle mechanism 150 becomes a predetermined angle at the time of mold touch when the movable mold 820 touches the fixed mold 810.

The mold clamping device 100 includes a mold thickness adjustment mechanism 180. The mold thickness adjustment mechanism 180 adjusts the mold thickness by adjusting the space L between the stationary platen 110 and the toggle support 130. The mold thickness adjustment is performed, for example, between the end of a molding cycle and the start of the next molding cycle. The mold thickness adjustment mechanism 180 includes, for example, a screw shaft 181 formed at the rear end of the tie bar 140, a screw nut 182 held by the toggle support 130 so as to be rotatable and not to advance and retract, and a mold thickness adjustment motor 183 that rotates the screw nut 182 screwed to the screw shaft 181.

The screw shaft 181 and the screw nut 182 are provided for each tie bar 140. The rotational driving force of the mold thickness adjustment motor 183 may be transmitted to the plurality of screw nuts 182 via a rotational driving force transmission unit 185. The plurality of screw nuts 182 can be rotated synchronously. Note that the plurality of screw nuts 182 can be individually rotated by changing the transmission path of the rotational driving force transmission unit 185.

The rotational driving force transmission unit 185 is configured by, for example, a gear. In this case, a driven gear is formed on the outer periphery of each screw nuts 182, a driving gear is attached to the output shaft of the mold thickness adjustment motor 183, and an intermediate gear which meshes with the plurality of driven gears and the driving gear is rotatably held at the center of the toggle support 130. The rotational driving force transmission unit 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nuts 182. As a result, the position of the toggle support 130 with respect to the tie bar 140 is adjusted, and the space L between the stationary platen 110 and the toggle support 130 is adjusted. A plurality of mold thickness adjustment mechanisms may be used in combination.

The space L is detected by using a mold thickness adjustment motor encoder 184. The mold thickness adjustment motor encoder 184 detects the rotation amount and the rotation direction of the mold thickness adjustment motor 183, and sends a signal indicating the detection result to the control device 700. The detection result of the mold thickness adjustment motor encoder 184 is used for monitoring and controlling the position of the toggle support 130 and the space L. The toggle support position detector for detecting the position of the toggle support 130 and the interval detector for detecting the space L are not limited to the mold thickness adjustment motor encoder 184, and general detectors can be used.

The mold clamping device 100 may include a mold temperature regulator that regulates the temperature of the mold device 800. The mold device 800 has a flow path for a temperature control medium therein. The mold temperature regulator regulates the temperature of the mold device 800 by regulating the temperature of the temperature regulating medium supplied to the flow path of the mold device 800.

The mold clamping device 100 of the present embodiment is a horizontal type in which the mold opening-closing direction is a horizontal direction, but may be a vertical type in which the mold opening-closing direction is a vertical direction.

The mold clamping device 100 of the present embodiment includes the mold clamping motor 160 as a drive source, but may include a hydraulic cylinder instead of the mold clamping motor 160. The mold clamping device 100 may include a linear motor for opening and closing the mold and an electromagnet for clamping the mold.

### (Ejector Device)

In the description of the ejector device 200, as in the description of the mold clamping device 100, the movement direction (for example, the X-axis positive direction) of the movable platen 120 when the mold is closed is described as the front, and the movement direction (for example, the X-axis negative direction) of the movable platen 120 when the mold is opened is described as the rear.

The ejector device 200 is attached to the movable platen 120 and advances and retracts together with the movable platen 120. The ejector device 200 includes an ejector rod 210 that ejects a molded product from the mold device 800, and a drive mechanism 220 that moves the ejector rod 210 in the moving direction (X-axis direction) of the movable platen 120.

The ejector rod 210 is disposed in a through-hole of the movable platen 120 so as to advance and retract. The front end of the ejector rod 210 is in contact with an ejector plate 826 of the movable mold 820. The front end of the ejector rod 210 may be connected to the ejector plate 826 or may not be connected to the ejector plate 826.

The drive mechanism 220 includes, for example, an ejector motor and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs the ejection step under the control of the control device 700. In the ejection step, the ejector rod 210 is moved forward from the standby position to the ejection position at a set moving speed, whereby the ejector plate 826 is moved forward to eject the molded product. Thereafter, the ejector motor is driven to move the ejector rod 210 backward at a set moving speed, and the ejector plate 826 is moved backward to the original standby position.

The position and the moving speed of the ejector rod 210 are detected by using, for example, an ejector motor encoder. The ejector motor encoder detects the rotation of the ejector motor and sends a signal indicating the detection result to the control device 700. The ejector rod position detector for detecting the position of the ejector rod 210 and the ejector rod moving speed detector for detecting the moving speed of the ejector rod 210 are not limited to the ejector motor encoder, and general detectors can be used.

### (Injection Device)

In the description of the injection device 300, unlike the description of the mold clamping device 100 and the description of the ejector device 200, the movement direction of the screw 330 during filling (for example, the X-axis negative direction) is referred to as the front side, and the movement direction of the screw 330 during measuring (for example, the X-axis positive direction) is referred to as the rear side.

The injection device 300 is installed on a slide base 301, and the slide base 301 is disposed so as to advance and retract with respect to an injection device frame 920. The injection device 300 is disposed so as to advance and retract with respect to the mold device 800. The injection device 300 touches the mold device 800 and fills the cavity space 801 in the mold device 800 with the molding material measured in the cylinder 310. The injection device 300 includes, for example, a cylinder 310 that heats the molding material, a nozzle 320 provided at a front end of the cylinder 310, a screw 330 disposed in the cylinder 310 so as to advance and retract and that is rotatable, a measuring motor 340 that rotates the screw 330, an injection motor 350 that advances and retracts the screw 330, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312 such as a water-cooled cylinder is provided on the outer periphery of the rear portion of the cylinder 310. A heater 313 such as a band heater and a temperature detector 314 are provided on the outer periphery of the cylinder 310 in front of the cooler 312.

The cylinder 310 is divided into a plurality of zones in the axial direction (for example, the X-axis direction) of the cylinder 310. The heater 313 and the temperature detector 314 are provided in each of the plurality of zones. A set temperature is set for each of the plurality of zones, and the control device 700 controls the heater 313 so that the temperature detected by the temperature detector 314 becomes the set temperature.

The nozzle 320 is provided at the front end of the cylinder 310 and is pressed against the mold device 800. A heater 313 and a temperature detector 314 are provided on the outer periphery of the nozzle 320. The control device 700 controls the heater 313 so that the detected temperature of the nozzle 320 becomes the set temperature.

The screw 330 is disposed in the cylinder 310 so as to be rotatable and retractable. When the screw 330 is rotated, the molding material is fed forward along the spiral groove of the screw 330. The molding material is gradually melted by the heat from the cylinder 310 while being fed forward. As the liquid molding material is fed to the front of the screw 330 and accumulated in the front portion of the cylinder 310, the screw 330 is moved backward. Thereafter, when the screw 330 is advanced, the liquid molding material accumulated in front of the screw 330 is injected from the nozzle 320 and is filled into the mold device 800.

A backflow prevention ring 331 is attached to the front portion of the screw 330 so as to be retractable as a backflow prevention valve that prevents backflow of the molding material from the front side to the rear side of the screw 330 when the screw 330 is pushed forward.

When the screw 330 is advanced, the backflow prevention ring 331 is pushed rearward by the pressure of the molding material in front of the screw 330, and is retracted relative to the screw 330 to a closing position (see FIG. 2) at which the flow path of the molding material is closed. This prevents the molding material accumulated in front of the screw 330 from flowing backward.

On the other hand, when the screw 330 is rotated, the backflow prevention ring 331 is pushed forward by the pressure of the molding material fed forward along the spiral groove of the screw 330, and moves forward relative to the screw 330 to an open position (see FIG. 1) at which the flow path of the molding material is opened. Thus, the molding material is fed to the front of the screw 330.

The backflow prevention ring 331 may be either a co-rotation type that rotates together with the screw 330 or a non-co-rotation type that does not rotate together with the screw 330.

The injection device 300 may include a drive source that advances and retracts the backflow prevention ring 331 between the open position and the closed position with respect to the screw 330.

The measuring motor 340 rotates the screw 330. The drive source for rotating the screw 330 is not limited to the measuring motor 340, and may be, for example, a hydraulic pump.

The injection motor 350 advances and retracts the screw 330. A motion conversion mechanism or the like for converting the rotational motion of the injection motor 350 into the linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source for advancing and retracting the screw 330 is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and the molding material, and is used for controlling or monitoring a pressure received by the screw 330 from the molding material, a back pressure to the screw 330, a pressure acting on the molding material from the screw 330, and the like.

The pressure detector for detecting the pressure of the molding material is not limited to the load detector 360, and a general pressure detector can be used. For example, a nozzle pressure sensor or a mold internal pressure sensor may be used. The nozzle pressure sensor is installed in the nozzle 320.

The injection device 300 performs a measuring step, a filling step, a holding pressure step, and the like under the control of the control device 700. The filling step and the holding pressure step may be collectively referred to as an injection step.

In the measuring step, the measuring motor 340 is driven to rotate the screw 330 at a set rotation speed, and the molding material is fed forward along the spiral groove of the screw 330. Accordingly, the molding material is gradually melted. As the liquid molding material is fed to the front of the screw 330 and accumulated in the front portion of the cylinder 310, the screw 330 is moved backward. The rotation speed of the screw 330 is detected by using, for example, the measuring motor encoder 341. The measuring motor encoder 341 detects the rotation of the measuring motor 340 and sends a signal indicating the detection result to the control device 700. The screw rotational speed detector for detecting the rotational speed of the screw 330 is not limited to the measuring motor encoder 341, and a general detector can be used.

In the measuring step, in order to limit the rapid retraction of the screw 330, the injection motor 350 may be driven to apply a set back pressure to the screw 330. The back pressure to the screw 330 is detected by using, for example, the load detector 360. When the screw 330 retracts to the measuring completion position and a predetermined amount of the molding material is accumulated in front of the screw 330, the measuring step is completed.

The position and the rotation speed of the screw 330 in the measuring step are collectively set as a series of setting conditions. For example, a measurement start position, a rotational speed switching position, and a measurement completion position are set. These positions are arranged in this order from the front side to the rear side, and represent the start point and the end point of the section in which the rotation speed is set. The rotation speed is set for each section. The rotational speed switching position may be one or more. The rotational speed switching position may not be set. Further, the back pressure is set for each section.

In the filling step, the injection motor 350 is driven to move the screw 330 forward at a set moving speed, and the liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350, and sends a signal indicating the detection result to the control device 700. When the position of the screw 330 reaches the set position, switching from the filling step to the holding pressure step (so-called V/P switching) is performed. The position where the V/P switching is performed is also referred to as a V/P switching position. The set moving speed of the screw 330 may be changed according to the position of the screw 330, time, or the like.

The position and the moving speed of the screw 330 in the filling step are collectively set as a series of setting conditions. For example, the filling start position (also referred to as “injection start position”) is set. The moving speed switching position and the V/P switching position are set. These positions are arranged in this order from the rear side to the front side and represent the start point and the end point of the section in which the moving speed is set. A moving speed is set for each section. The number of the moving speed switching positions may be one or more. The moving speed switching position may not be set.

The upper limit value of the pressure of the screw 330 is set for each section in which the moving speed of the screw 330 is set. The pressure of the screw 330 is detected by the load detector 360. When the pressure of the screw 330 is equal to or lower than the set pressure, the screw 330 is moved forward at the set moving speed. On the other hand, when the pressure of the screw 330 exceeds the set pressure, the screw 330 is advanced at a moving speed lower than the set moving speed so that the pressure of the screw 330 becomes equal to or lower than the set pressure for the purpose of protecting the mold.

Note that, after the position of the screw 330 reaches the V/P switching position in the filling step, the screw 330 may be temporarily stopped at the V/P switching position, and then the V/P switching may be performed. Immediately before the V/P switching, the screw 330 may be advanced or retracted at a very low speed instead of stopping the screw 330. Further, the screw position detector for detecting the position of the screw 330 and the screw moving speed detector for detecting the moving speed of the screw 330 are not limited to the injection motor encoder 351, and general detectors can be used.

In the holding pressure step, the injection motor 350 is driven to push the screw 330 forward, and the pressure of the molding material at the front end of the screw 330 (hereinafter, also referred to as “holding pressure”) is increased. The molding material remaining in the cylinder 310 is pushed toward the mold device 800. The molding material can be replenished for the shortage due to cooling shrinkage in the mold device 800. The holding pressure is detected by using, for example, the load detector 360. The set value of the holding pressure may be changed according to the elapsed time from the start of the holding pressure step. A plurality of holding pressures and a plurality of holding times for holding the holding pressures in the holding pressure step may be set, and may be collectively set as a series of setting conditions.

In the holding pressure step, the molding material in the cavity space 801 in the mold device 800 is gradually cooled, and when the holding pressure step is completed, the inlet of the cavity space 801 is closed by the solidified molding material. This state is called a gate seal, and the backflow of the molding material from the cavity space 801 is prevented. After the holding pressure step, the cooling step starts. In the cooling step, the molding material in the cavity space 801 is solidified. In order to shorten the molding cycle time, the measuring step may be performed during the cooling step.

The injection device 300 of the present embodiment is of an in-line screw type, but may be of a pre-plasticizing type or the like. The pre-plasticizing injection device supplies a molding material melted in a plasticizing cylinder to an injection cylinder, and injects the molding material from the injection cylinder into a mold device. The screw is in the plasticizing cylinder in a rotatable and non-retractable manner, or the screw is arranged in a rotatable and retractable manner. On the other hand, a plunger is disposed in the injection cylinder in a retractable manner.

Further, the injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the horizontal injection device 300 may be horizontal type or vertical type.

### (Moving Device)

In the description of the moving device 400, as in the description of the injection device 300, the moving direction (for example, the X-axis negative direction) of the screw 330 during filling is referred to as the front side, and the moving direction (for example, the X-axis positive direction) of the screw 330 during measuring is referred to as the rear side.

The moving device 400 advances and retracts the injection device 300 with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 has a first port 411 and a second port 412. The hydraulic pump 410 is a pump capable of rotating in both directions, and generates a hydraulic pressure by switching the rotation direction of the motor 420 to suck a working fluid (for example, oil) from one of the first port 411 or the second port 412 and discharge the working fluid from the other one of the first port 411 or the second port 412. The hydraulic pump 410 can also suck the working fluid from the tank and discharge the working fluid from either one of the first port 411 or the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder body 431, a piston 432, and a piston rod 433. The cylinder body 431 is fixed to the injection device 300. The piston 432 divides the inside of the cylinder body 431 into a front chamber 435 as a first chamber and a rear chamber 436 as a second chamber. The piston rod 433 is fixed relative to the stationary platen 110.

The front chamber 435 of the hydraulic cylinder 430 is connected to the first port 411 of the hydraulic pump 410 via the first flow path 401. The working fluid discharged from the first port 411 is supplied to the front chamber 435 via the first flow path 401, and thus the injection device 300 is pushed forward. The injection device 300 is advanced, and the nozzle 320 is pressed against the fixed mold 810. The front chamber 435 functions as a pressure chamber that generates a nozzle touch pressure of the nozzle 320 by the pressure of the working liquid supplied from the hydraulic pump 410.

On the other hand, the rear chamber 436 of the hydraulic cylinder 430 is connected to the second port 412 of the hydraulic pump 410 via a second flow path 402. The hydraulic fluid discharged from the second port 412 is supplied to the rear chamber 436 of the hydraulic cylinder 430 via the second flow path 402, whereby the injection device 300 is pushed rearward. The injection device 300 is retracted, and the nozzle 320 is separated from the fixed mold 810.

In the present embodiment, the moving device 400 includes the hydraulic cylinder 430, but the present disclosure is not limited thereto. For example, instead of the hydraulic cylinder 430, an electric motor and a motion conversion mechanism that converts the rotational motion of the electric motor into the linear motion of the injection device 300 may be used.

### (Control Device)

The control device 700 is configured by, for example, a computer, and includes circuitry, or a central processing unit (CPU) 701, a storage medium 702 such as a memory, an input interface 703, an output interface 704, and a communication interface (I/F) 705 as illustrated in FIGS. 1 and 2. The control device 700 performs various controls by causing the CPU 701 to execute the program stored in the storage medium 702. The control device 700 receives a signal from the outside through the input interface 703 and transmits a signal to the outside through the output interface 704.

The control device 700 repeatedly performs the measuring step, the mold closing step, the pressurizing step, the mold clamping step, the filling step, the pressure holding process, the cooling process, the depressurizing process, the mold opening step, the ejection step, and the like, and thus repeatedly produces the molded product. A series of operations for obtaining a molded product, for example, an operation from the start of a measuring step to the start of the next measuring step is also referred to as a “shot” or a “molding cycle”. The time required for one shot is also referred to as “molding cycle time” or “cycle time”.

One molding cycle includes, for example, a measuring step, a mold closing step, a pressurizing step, a mold clamping step, a filling step, a holding pressure step, a cooling step, a depressurizing step, a mold opening step, and an ejection step in this order. The order here is the order of the start of each step. The filling step, the holding pressure step, and the cooling step are performed during the mold clamping step. The start of the mold clamping step may match the start of the filling step. The completion of the depressurizing step matches the start of the mold opening step.

A plurality of steps may be performed simultaneously for the purpose of shortening the molding cycle time. For example, the measuring step may be performed during the cooling step of the previous molding cycle, or may be performed during the mold clamping step. In this case, the mold closing step may be performed at the start of the molding cycle. The filling step may start during the mold closing step. The ejection step may start during the mold opening step. In a case where an opening-closing valve that opens and closes the flow path of the nozzle 320 is provided, the mold opening step may start during the measuring step. This is because even if the mold opening step starts during the measuring step, the molding material does not leak from the nozzle 320 as long as the on-off valve closes the flow path of the nozzle 320.

One molding cycle may include a step other than the measuring step, the mold closing step, the pressurizing step, the mold clamping step, the filling step, the holding pressure step, the cooling process, the depressurizing step, the mold opening step, and the ejection step.

For example, after the completion of the holding pressure step, before the start of the measuring step, a pre-measuring suck back process of retracting the screw 330 to a predetermined measuring start position may be performed. The pressure of the molding material accumulated in front of the screw 330 before the start of the measuring step can be reduced, and the rapid retraction of the screw 330 at the start of the measuring step can be prevented.

After the completion of the measuring step and before the start of the filling step, the screw 330 is moved to a preset filling start position (also referred to as an “injection start position”). The suck-back step may be performed after the measurement. The pressure of the molding material accumulated in front of the screw 330 before the start of the filling step can be reduced, and the leakage of the molding material from the nozzle 320 before the start of the filling step can be prevented.

The control device 700 is connected to an operation device 750 that receives an input operation by a user and a display device 760 that displays a screen. The operation device 750 and the display device 760 may be configured by, for example, a touch panel 770 and may be integrated. The touch panel 770 as the display device 760 displays a screen under the control of the control device 700. For example, information such as the setting of the injection molding machine 10 and the current state of the injection molding machine 10 may be displayed on the screen of the touch panel 770. The touch panel 770 can receive an operation in a displayed screen area. In addition, for example, an operation unit such as a button or an input field for receiving an input operation by the user may be displayed in the screen region of the touch panel 770. The touch panel 770 as the operation device 750 detects an input operation on the screen by the user and outputs a signal corresponding to the input operation to the control device 700. Thus, for example, the user can perform setting (including input of a setting value) of the injection molding machine 10 by operating the operation unit provided on the screen while checking the information displayed on the screen. Further, the user can operate the operation unit provided on the screen to cause the injection molding machine 10 to perform an operation corresponding to the operation unit. Note that the operation of the injection molding machine 10 may be, for example, the operation (including stopping) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided independently. A plurality of operation devices 750 may be provided. The operation device 750 and the display device 760 are disposed on the operation side (Y-axis negative direction) of the mold clamping device 100 (more specifically, the stationary platen 110).

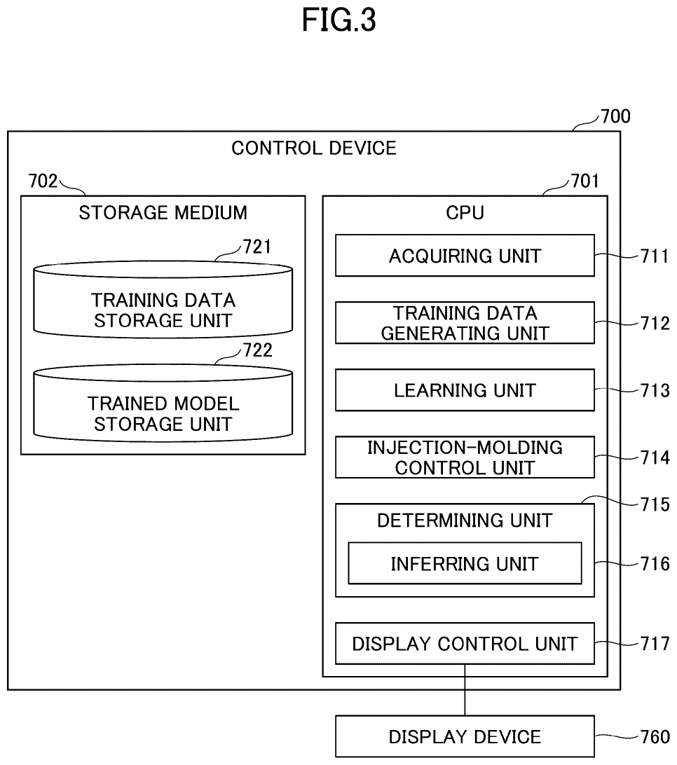

FIG. 3 is a diagram illustrating an example of a functional configuration of the control device 700 according to the present embodiment. As illustrated in FIG. 3, the constituent elements of the control device 700 of the injection molding machine 10 are illustrated by functional blocks. Each functional block illustrated in FIG. 3 is conceptual, and is not necessarily physically configured as illustrated in the figure. All or some of the functional blocks may be configured to be functionally or physically distributed or integrated in arbitrary units. All or any part of the processing functions performed by the functional blocks are implemented by a program executed in the CPU 701. Alternatively, each functional block may be implemented as hardware by wired logic. As illustrated in FIG. 3, the CPU 701 of the control device 700 includes an acquiring unit 711, a training data generating unit 712, a learning unit 713, an injection-molding control unit 714, a determining unit 715 including an inferring unit 716, and a display control unit 717. The control device 700 includes a training data storage unit 721 and a trained model storage unit 722 in the storage medium 702. In the present embodiment, a case where the control device 700 functions as a monitoring device of the injection molding machine 10 will be described.

The training data storage unit 721 stores training data used for training of the trained model LM. The configuration of the training data will be described later.

The trained model storage unit 722 stores the trained model LM.

The acquiring unit 711 acquires, from the injection molding machine 10, waveform data indicating detection results by sensors provided in the injection molding machine 10 in a time series. In the present embodiment, the acquiring unit 711 acquires the waveform data from the start to the end of the molding cycle of the injection molding machine 10. In the present embodiment, the waveform data to be acquired is not limited to the waveform data from the start to the end of the molding cycle, and the waveform data to be acquired may be waveform data for each shot. For example, the waveform data may be waveform data indicating a part or an entirety of the molding cycle, or waveform data approaching the previous or following shot.

The waveform data to be acquired includes, for example, first waveform data indicating mold clamping force detection values detected by the mold clamping force detector in a time series, second waveform data indicating pressures received by the screw 330 from the molding material in a time series, which are calculated based on signals of the load detected by the load detector 360, and third waveform data indicating positions of the screw 330 detected using the injection motor encoder 351 in a time series. Note that the present embodiment illustrates an example of the waveform data; however, the waveform data is not limited to the first waveform data to the third waveform data. For example, instead of using all of the first waveform data to the third waveform data, any one or more of the first waveform data to the third waveform data may be used. Further, waveform data indicating detection results detected by other sensors provided in the injection molding machine 10 in a time series may be used.

The training data generating unit 712 generates training data by combining the waveform data acquired by the acquiring unit 711 and ground truth information indicating an evaluation of the molded product produced when the waveform data is detected. Then, the training data generating unit 712 stores the generated training data in the training data storage unit 1321.

The ground truth information according to the present embodiment is quantitative data (continuous measurement) indicating the evaluation of the product. The quantitative data includes both discrete values such as integers and continuous values such as real numbers. In the present embodiment, the weight of the molded product measured after production is used as the ground truth information. In the present embodiment, an example in which the weight of the molded product is used as the ground truth information will be described, but the ground truth information is not limited to the weight. That is, the ground truth information may be any quantitative data insofar as the quantitative data represents the state of the produced molded product or the molding material during molding.

That is, when the user refers to the first waveform data to the third waveform data, it is difficult to determine whether an abnormality has occurred in a molded product. In contrast, the trained model LM according to the present embodiment outputs quantitative data representing the state of the produced molded product, a molding material during molding, or the like when the first waveform data to the third waveform data are input to the trained model LM. Since the output information is quantitative data, it is possible to easily determine whether an abnormality has occurred.

The learning unit 713 generates the trained model LM by performing machine learning based on the training dataset stored in the training data storage unit 721. The trained model LM is generated by applying supervised learning to the base learning model.

Specifically, the learning unit 713 generates the trained model LM by performing machine learning based on the waveform data (an example of second data) and the weight of the molded product (an example of a second value) included in the training dataset.

The trained model LM outputs the weight (an example of the first value) of the molded product from the output layer when waveform data (an example of first data) indicating the time series of each of the detected mold clamping force, the pressure received from the molded material, and the position of the screw 330 detected while the injection molding machine 10 performs molding is input from the input layer. As described above, in the present embodiment, the output data from the output layer of the trained model LM is a regression model.

In addition, the trained model LM may be updated by additionally training the existing trained model LM with a new training dataset.

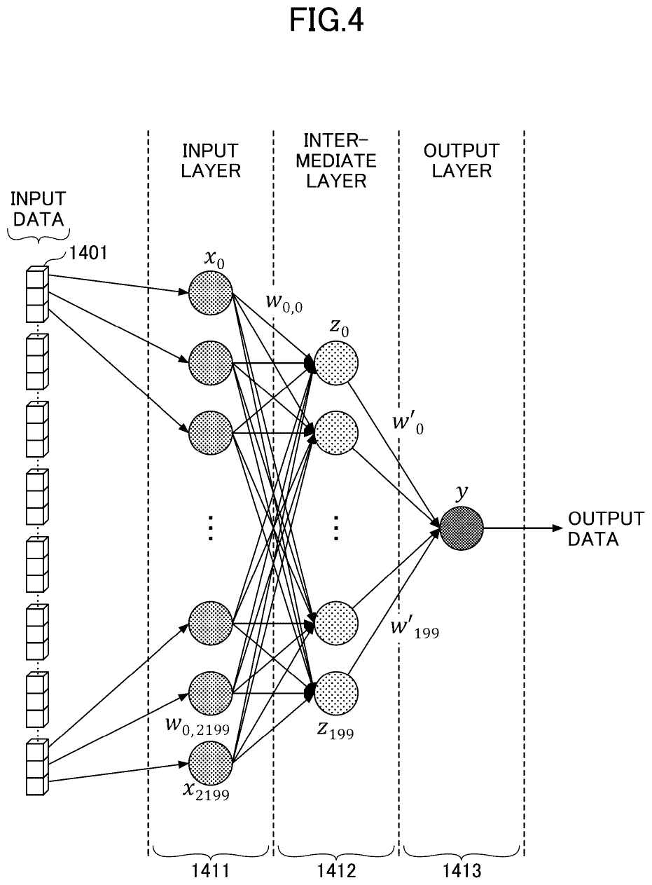

FIG. 4 is a diagram illustrating a structure of the trained model LM used in the control device 700 according to the embodiment.

The trained model LM illustrated in FIG. 4 is configured to include an input layer 1411, one or two or more intermediate layers 1412 connected to the input layer, and an output layer 1413 connected to the intermediate layers. The input layer has, for example, 2200 nodes, the intermediate layer has, for example, 200 nodes, and the output layer has 1 node.

When input data 1401 corresponding to the 2200 nodes are input, the trained model LM outputs the output data y corresponding to the 1 node.

The input data 1401 are, for example, first waveform data indicating mold clamping force detection values detected by the mold clamping force detector in a time series, second waveform data indicating the pressures received by the screw 330 from the molding material in a time series calculated based on the signals of the load detected by the load detector 360, and third waveform data indicating the positions of the screw 330 detected using the injection motor encoder 351 in a time series.

The output data y is, for example, the weight of the injection molded product.

When the learning unit 713 performs learning using the training data, preprocessing may be performed on the waveform data included in the training data. The preprocessing may be performed when the inferring unit 716 to be described later performs inference.

In the example illustrated in FIG. 4, in the input layer, variables corresponding to the respective nodes are defined as input variable vectors x₀₋₂₁₉₉. In the intermediate layer, variables corresponding to the respective nodes are defined as intermediate variable vectors z₀₋₁₉₉. In the output layer, a variable corresponding to a node is defined as output data y.

In this case, the intermediate variable vector z₀ of the intermediate layer is calculated by the following Equation (1). In Equation (1), the weight vectors w_{0, 0-2199} are (2200 dimensional) weight vectors for outputting each value of the intermediate variable vector z₀ from each node of the input layer. The intermediate variable vectors z₁₋₁₉₉ can also be calculated by using the same equation, and thus the description thereof will be omitted. The biases b₀₋₁₉₉ are not illustrated in FIG. 4, but the biases b₀₋₁₉₉ are biases used in the neural network. As the activation function φ, for example, a ReLU function may be used, but another function may be used.

$${z}_{0} = φ ( {w}_{0 , 0 - 2199} \cdot {x}_{0 - 2199} + {b}_{0} ) \qquad ( 1 )$$

The output data y of the output layer is calculated by the following Equation (2). In Equation (2), weight vectors w′₀₋₁₉₉ are weight vectors for outputting a value from each node of the intermediate layer to the output data y. The bias b′ is not illustrated in FIG. 4, but is a bias used in the neural network. As the activation function φ′, for example, a ReLU function may be used, but another function may be used.

$$y = {φ}^{′} ( {w}_{0 - 199}^{′} \cdot {z}_{0 - 199} + {b}^{′} ) \qquad ( 2 )$$

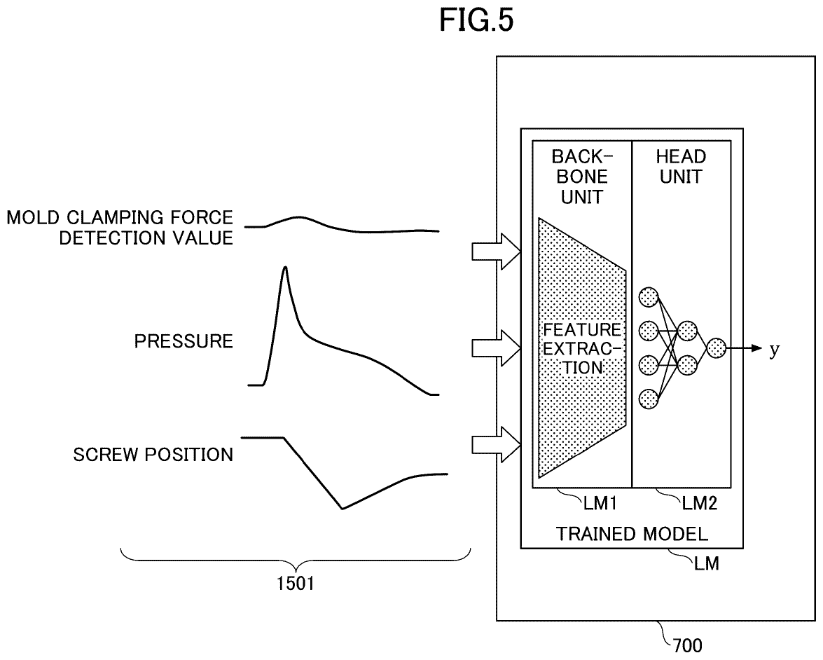

FIG. 5 is a conceptual diagram illustrating a structure of the trained model LM according to the present embodiment. As illustrated in FIG. 5, the trained model LM according to the present embodiment includes a backbone unit LM1 and a head unit LM2.

The backbone unit LM1 is a neural network for extracting features from an input waveform, and deep learning may be applied as a training method. As an algorithm of deep learning, a deep neural network (DNN) may be used. Deep neural networks (DNNs), convolutional neural networks (CNNs), or recurrent neural networks (RNNs) may be applied as deep learning algorithms. Furthermore, a long short-term memory (LSTM) or a transformer may be applied.

The neural network of the backbone unit LM1 is a neural network designed to extract features from a waveform, for example, a neural network in which connections between nodes are limited, a neural network in which parameters are shared between different nodes, and a neural network in which feedback connections are provided.

As a result of the machine learning, the extraction of the feature by the backbone unit LM1 can extract a relationship between the detection results of the sensors included in the plurality of waveform datasets.

The head unit LM2 may be configured to output the qualitative characteristics of the molded product or the molded material from the extracted feature, and may be a fully connected layer neural network.

The quality characteristics of the molded product may be any characteristics that can be illustrated as quantitative data by a measuring instrument or a test after molding, such as shape or dimensions (width, height, thickness), size of appearance defects (scorching, silver streak, cold slug, etc.), warpage, strength, and the like. The quality characteristics used in the present embodiment are not limited to the quality characteristics of the molded product, in other words, the data measurable after the injection molding as described above, and may be the state of the molding material during the injection molding, for example, the viscosity, specifically, the melt mass flow rate (MFR), the melt volume rate (MVR), or the like as quantitative data indicating the fluidity of the molding material. Any method may be used as a method of acquiring the quality characteristics of the molded product or the molding material.

In the present embodiment, the calculation of the head unit LM2 for deriving the characteristics of the molded product or the molded material from the feature is not limited to the method using the neural network. For example, a regression model that is not a neural network may be used. In this case, after machine learning is performed on a configuration including the backbone unit LM1 and the head unit LM2 in the first machine learning, parameters until the feature of the backbone unit LM1 is extracted may be fixed in the second machine learning and inference, and the algorithm may be replaced with another algorithm (for example, decision tree, random forest, gradient boosting, SVR, or the like) in the head unit LM2.

In the present embodiment, a case where the input data 1501 is time-series data of the result detected by the sensor for each shot, and includes first waveform data indicating the mold clamping force detection values detected by the mold clamping force detector in a time series, second waveform data indicating the pressure received by the screw 330 from the molding material calculated based on the signal of the load detected by the load detector 360 in a time series, and third waveform data indicating the position of the screw 330 detected using the injection motor encoder 351 in a time series will be described. However, in the present embodiment, input data to be input to the trained model LM is not restricted. For example, the input data may be any one or more of the first waveform data to the third waveform data, and may include time-series data of a result detected by another sensor.

Further, transfer learning may be used as a training method of the trained model LM. For example, the first machine learning may be performed without using the ground truth information for a part (for example, the backbone unit LM1) of the neural network included in the trained model LM, and then the second machine learning may be performed using the ground truth information.

In this method, the first machine learning may be performed without using the ground truth information, and the second machine learning may be performed according to the type of the ground truth information after fixing the parameters until the feature of the backbone unit LM1 is extracted. Thus, a plurality of trained models LMs are generated, and each of the plurality of trained models LMs can output a different quality characteristic. For example, one trained model LM can output the weight of the molded product when the first waveform data to the third waveform data are input, and the other trained model LM can output the viscosity of the molding material when the first waveform data to the third waveform data are input.

The output data y is output from the trained model LM as quantitative data by the regression model. In this way, the final output of the trained model LM is configured as a single node, and the MSE (mean square error) or the MAE (mean absolute error) is applied as the error function, thereby implementing the learning.

Further, the output data y output by the trained model LM may be output as a quality characteristic of the molded product other than the weight, and the quality characteristic may be converted into the weight.

The output data y output by the trained model LM may be a quality characteristic of a molded product, a molding material, a component of the injection molding machine 10, or the like. That is, the output data y output from the trained model LM may be quantitative data capable of determining the abnormality.

In the present embodiment, among the quality characteristics of the molded product or the molding material, a quality characteristic that can be represented as quantitative data is output as the output data y from the trained model LM. In the present embodiment, the quality characteristics that can be output as the output data y are not limited to the molded product or the molding material. The quality characteristics that can be output as the output data y may be, for example, a set value of a molding condition, a detection value that is a basis of the molding condition, a detection value of a molded product after molding, a state of a molding material during molding, dimensions of components (for example, the mold device 800) of the injection molding machine 10, a deterioration amount, and the like. Then, it may be determined whether an abnormality has occurred using these quality characteristics.

Returning to FIG. 3, the learning unit 713 stores the generated trained model LM in the trained model storage unit 722.

The injection-molding control unit 714 executes a process for producing a molded product by the injection molding machine 10. For example, the injection-molding control unit 714 may perform injection molding after setting each item configuring a molding condition when producing a molded product.

The determining unit 715 includes the inferring unit 716 and determines whether an abnormality (defect) has occurred in the molded product, based on the information acquired from the inferring unit 716.

For example, the inferring unit 716 inputs, to the input layer of the trained model LM, waveform data (an example of first data) indicating a result detected by the mold clamping force detector while a molded product is produced by the injection-molding control unit 714, and acquires, from the output layer of the trained model LM, a value representing an evaluation of the molded product as quantitative data. In the present embodiment, a case where the value to be acquired (an example of a first value) is the weight of the molded product or the viscosity of the molding material during molding will be described.

The inferring unit 716 may perform preprocessing on the waveform data before inputting the waveform data to the input layer.

Then, the determining unit 715 determines whether an abnormality has occurred in the detection result of the sensor provided in the injection molding machine 10 based on the quantitative data (for example, the weight of the molded product or the viscosity of the molding material during molding) of the quality characteristics of the molded product received from the inferring unit 716. The criteria for determining whether an abnormality has occurred may be set by the user.

The display control unit 717 displays information on the display device 760.

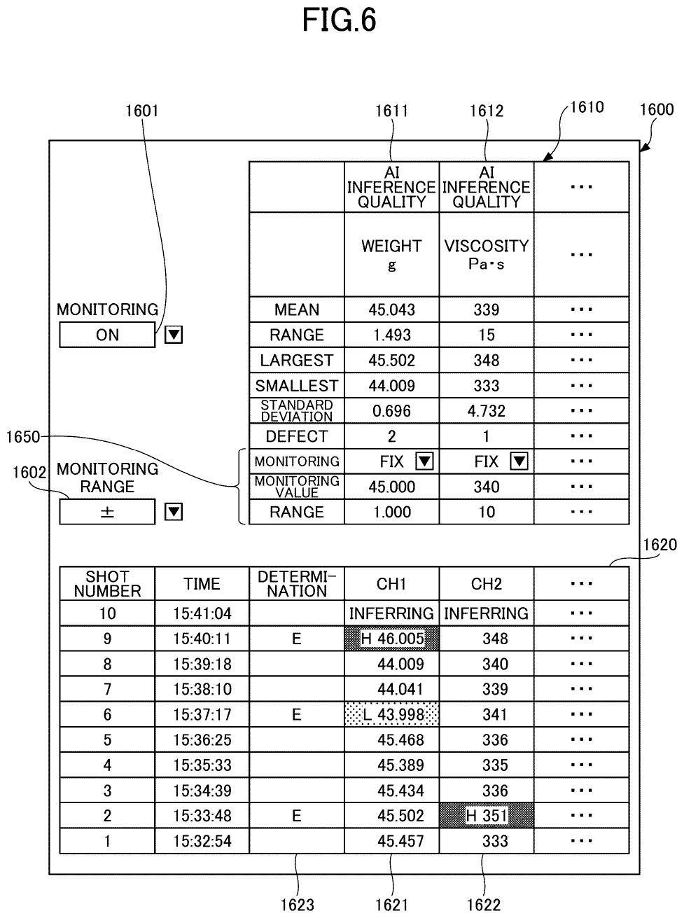

FIG. 6 is a diagram illustrating a log information screen displayed by a display control unit 717 according to the present embodiment. In the log information screen illustrated in FIG. 6, the user can set criteria for determining whether the log information is abnormal.

The log information screen 1600 illustrated in FIG. 6 includes a monitoring setting menu 1601, a monitoring range setting menu 1602, a statistics list 1610, and an actual results list 1620.

The statistics list 1610 illustrates statistics (for example, the mean, the range, the largest value, the smallest value, and a standard deviation) for each of the setting fields 1611 to 1612. The contents displayed in the setting fields 1611 to 1612 can be set by the user. In the present embodiment, items displayed in the setting fields 1611 to 1612 can be displayed, monitored, and log information can be stored. The monitoring in the present embodiment represents determining whether the product is a non-defective product based on predetermined criteria.

The “monitoring”, the “monitoring value”, and the “range” of the monitoring item 1650 included in the statistical list are information set to determine whether the molded product is defective.

When “monitoring” of the statistics list 1610 is “off”, the control device 700 does not perform monitoring, and when “monitoring” is “fixed” or “automatic”, the control device 700 performs monitoring. In the case of “fixed” or “automatic”, the control device 700 determines whether the detected value satisfies the criteria indicated by “monitored value” and “range” in the items indicated by the setting fields 1611 and 1612. The switching of the monitoring is performed by the monitoring setting menu 1601.

The “monitoring value” is set to the median for discriminating the quality characteristics of the molded product. The “range” sets the upper and lower limits for determining whether the product is defective or not, with the “monitored value” at the center.

The “defect” of the statistics list 1610 indicates the number of molded products that do not satisfy the criteria indicated by the “monitoring value” and the “range”.

The “weight g” of “AI inference quality” in the setting field 1611 and the “viscosity Pa·s” of “AI inference quality” in the setting field 1612 are respective items set to monitor the weight output by the trained model LM and the viscosity output by the trained model LM.

That is, in the example illustrated in FIG. 6, the trained model LM that outputs “weight” and the trained model LM that outputs “viscosity” are stored in the trained model storage unit 722 in advance. Then, the inferring unit 716 inputs waveform data (for example, the first waveform data to the third waveform data described above) indicating detection results by the sensor in a time series for each shot to each of the trained model LM that outputs “weight” and the trained model LM that outputs “viscosity”. Thus, the inferring unit 716 receives the inference result of “weight” and the inference result of “viscosity”. Then, the determining unit 715 determines whether the molded product is abnormal for each of the inference result of “weight” and the inference result of “viscosity”.

In the present embodiment, an example in which the weight of the molded product output from the trained model LM is represented by a measurement unit [g], and the viscosity of the molding material is represented by the measurement unit [Pa·s] has been described. That is, since quantitative data representing the quality characteristics of the molded product or the molding material is represented based on a specific index, which is a measurement unit, the user can easily grasp the quality characteristics.

When the screen illustrated in FIG. 6 is displayed, the determining unit 715 determines whether the molded product is abnormal according to whether each of the inference result of “weight” or the inference result of “viscosity” satisfies the criteria indicated by a “monitoring value” and a “range”. The determination criteria indicated by “monitoring value” and “range” are set based on the measurement unit of a determination target (for example, weight or viscosity).

For example, in the setting field 1611, the determining unit 715 determines whether the inference result of “weight” is included within the “range” of ±“1.000” [g], using the “monitored value” of “45.000” [g] as a reference. That is, the determining unit 715 determines that an abnormality has occurred when the “weight” is larger than “46.000” [g] (an example of a predetermined threshold), and determines that an abnormality has occurred when the “weight” is smaller than “44.000” [g] (an example of the predetermined threshold).

Similarly, in the setting field 1612, the determining unit 715 determines whether the inference result of “viscosity” is included within the “range” of ±“10” [Pa·s], using the “monitoring value” of “340” [Pa·s] as a reference. That is, the determining unit 715 determines that an abnormality has occurred when the “viscosity” is larger than “350” [Pa·s] (an example of the predetermined threshold), and determines that an abnormality has occurred when the “viscosity” is smaller than “330” [Pa·s] (an example of a predetermined threshold).

The determination result of the determining unit 715 is displayed in the actual results list 1620.

The setting fields 1611 to 1612 can be changed to items that the user desires to monitor. The description of the changing method is omitted.

The actual results list 1620 represents a list of quality characteristics of the molded product output by the trained model LM in the items set in the setting fields 1611 to 1612 for each shot.

In the present embodiment, an example in which the quality characteristics of the molded product output by the trained model LM are output to the actual results list 1620 will be described, but the information output to the actual results list 1620 is not limited to the quality characteristics, and may include, for example, any one or more of setting information set for performing injection molding and detection values measured by various sensors.

The output results of the items set in the setting fields 1611 to 1612 are illustrated in the “CH1” field 1621 to the “CH2” field 1622. In the actual results list 1620, for each shot, “shot number”, “time” at which injection molding was performed, and “identification” of injection molding are associated with each other, as information indicating the shot.

In the “CH1” field 1621 to the “CH2” field 1622, when the “monitoring” is “fixed” or “automatic”, and the quality characteristic is larger than the upper limit value defined by the “monitoring value” and the “range”, “H” is displayed. On the other hand, when the quality characteristic is smaller than the lower limit value defined by the “monitoring value” and the “range”, “L” is displayed.

In the “determination”, “E (defect)” is displayed when it is determined that at least one or more CHs of the monitoring target do not satisfy the criteria in the shot. For example, “E (defective)” is displayed for a shot for which “H” or “L” is displayed in either the “CH1” field 1621 or the “CH2” field 1622.

Then, each time “E” is displayed in “determination”, the numerical value is increased by “1” in “failure” of the corresponding setting field of the statistics list 1610.

The monitoring setting menu 1601 is a button for receiving whether to monitor according to the items to be monitored in the statistics list 1610. When “ON” is selected in the monitoring setting menu 1601, whether the shot is defective is monitored for each shot, and the monitoring result is displayed in “determination” of the actual results list 1620. In the monitoring setting menu 1601, the monitoring setting menu 1601 is switched to “OFF” or “ON” in response to an operation from the user.

The monitoring range setting menu 1602 is selected from “[±]” and “[+ to −]”. The “[±]” monitors the same range from the “monitored value” as the center to each of the positive and negative sides. The “[+ to −]” sets the ranges of the positive side and the negative side separately monitored with the “monitored value” as the center.

In the injection molding machine 10, an instruction may be given to an external device so that a molded product determined to be “defective” (abnormal) is removed from shipment.

Furthermore, when a molded product is suspected to be defective after shipment, the information represented by the statistics list 1610 and the actual results list 1620 in FIG. 6 may be stored so that the quality characteristics of the molded product can be checked. This can be used for traceback such as checking the inference results of the quality characteristics of the defect.

In the present embodiment, the numerical values of the quality characteristics of the molded product output by the trained model LM may not be accurate. That is, since the numerical values (quantitative data) of the quality characteristics of the molded product output by the trained model LM are values used instead of monitoring the waveform data, the numerical values may be values capable of determining whether the molded product is defective, based on the above-described “monitoring value”, “range”, and the like. For example, in a case where there is a correspondence relationship between the presence or absence of a burr and the weight received from the trained model LM, it is possible to detect the presence or absence of a burr by setting a threshold with respect to the weight received from the trained model LM in the present embodiment. However, the weight received from the trained model LM does not need to accurately match the weight of the molded product output from the injection molding machine 10. In other words, the weight received from the trained model LM may not be an accurate weight, and may be associated with the abnormality to be detected (for example, the presence or absence of the occurrence of the burr).

FIG. 6 illustrates a case where the log information screen includes the monitoring function. However, the present embodiment is not limited to the case where the log information screen includes the monitoring function. A monitoring setting screen may be prepared separately from the log information screen.

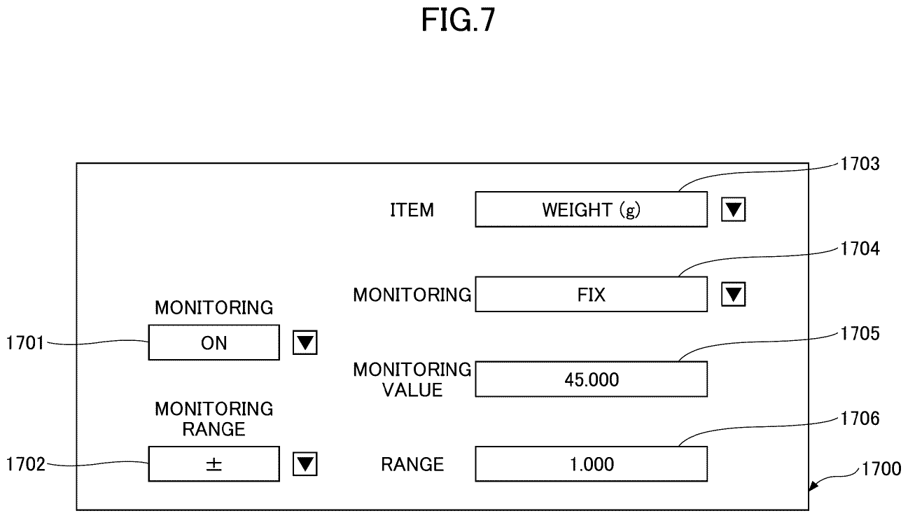

FIG. 7 is a diagram illustrating an example of the monitoring setting screen displayed by the display control unit 717 according to the present embodiment.

The monitoring setting screen 1700 illustrated in FIG. 7 includes a monitoring setting menu 1701, a monitoring range setting menu 1702, an item selection field 1703, a monitoring menu 1704, a monitoring value setting field 1705, and a range setting field 1706.

The monitoring setting menu 1701 and the monitoring range setting menu 1702 are the same as the monitoring setting menu 1601 and the monitoring range setting menu 1602 of FIG. 6.

The item selection field 1703 is a field for selecting the type of quality characteristics output by the trained model LM. In the present embodiment, the trained model LM can be selected according to the type of the trained model LM stored in the trained model storage unit 722.

The monitoring menu 1704 is a menu for receiving a selection from “off”, “fixed”, and “automatic”. In the case of “off”, the control device 700 does not perform monitoring, and in the case of “fixed” or “automatic”, the control device 700 performs monitoring.

The monitoring value setting field 1705 is a field for setting the median for determining the quality characteristics of the molded product.

The range setting field 1706 is a field for setting the upper and lower limits for determining whether the defect is present, with the “monitored value” as the center.

When the setting of each field illustrated in FIG. 7 is performed, the control device 700 determines whether the molded product is abnormal based on the quality characteristics. When the molded product is determined to be abnormal, the molded product may be removed as an abnormal molded product from the production line, a user may be notified of the occurrence of abnormality, or the production of the molded product may be stopped. In this way, any countermeasure may be taken as the abnormality countermeasure, regardless of the known countermeasures.

In addition, the control device 700 can detect an abnormality (defect) of the molded product by the above-described method. It may then be possible to set what kind of control is performed when a defect is detected.

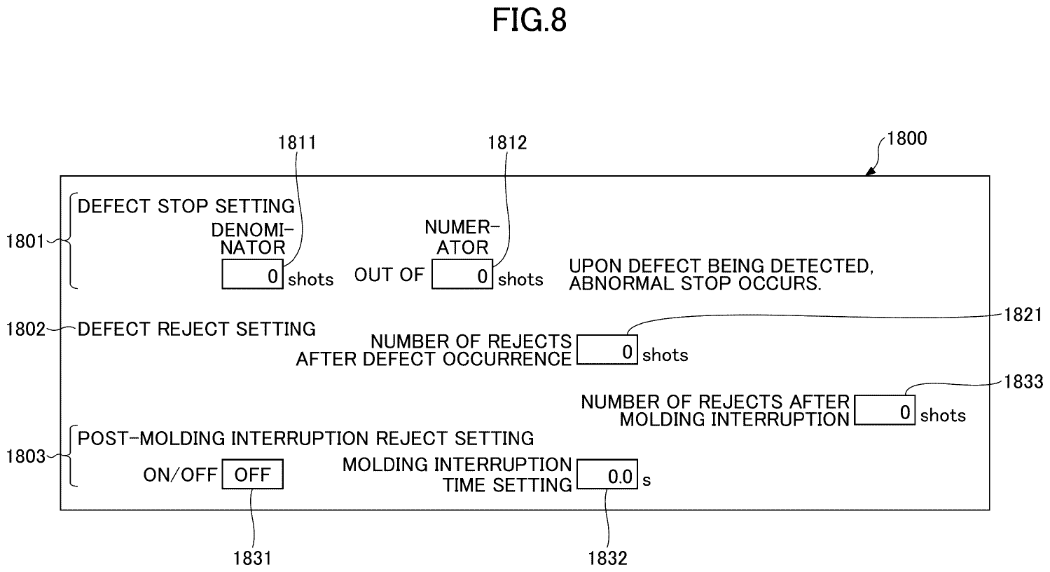

FIG. 8 is a diagram illustrating an operation setting screen upon a defect being detected displayed by the display control unit 717 according to the present embodiment.

The operation setting screen 1800 upon a defect being detected, illustrated in FIG. 8, includes a defect stop setting field 1801, a defect reject setting field 1802, and a post-molding interruption reject setting field 1803.

The defect stop setting field 1801 includes a denominator field 1811 and a numerator field 1812. The denominator field 1811 sets the number of shots to be a denominator when the defect stop is performed. The numerator field 1812 sets the number of shots serving as a numerator when the defect stop is performed.

That is, when the determining unit 715 determines, upon the injection molding machine 10 producing a molded product, that the number of abnormalities (defects) indicated in the numerator field 1812 have occurred out of the number indicated in the denominator field 1811, based on the quality characteristics output by the trained model LM, the injection-molding control unit 714 performs control to stop injection molding.

The defect reject setting field 1802 includes the number of rejects after defect occurrence 1821. The number of rejects after defect occurrence 1821 sets the number of molded products to be rejected thereafter when the determining unit 715 determines that an abnormality has occurred based on the quality characteristics output by the trained model LM.

When the determining unit 715 determines that an abnormality has occurred based on the quality characteristics output by the trained model LM, the control device 700 instructs to reject the molded products produced after the molded product is determined to be abnormal by the number set in the number of rejects after defect occurrence 1821.

The post-molding interruption reject setting field 1803 includes a post-molding interruption reject setting 1831, a molding interruption time setting 1832, and the number of rejects after molding interruption 1833. The post-molding interruption reject setting 1831 sets whether to reject the molded product after the injection molding is interrupted, by “ON” or “OFF”. The molding interruption time setting 1832 is a field for setting a time for determining that the injection molding is interrupted. When the molding is interrupted for a time set or more in the molding interruption time setting 1832, the rejection being performed after the interruption is determined. The control device 700 instructs to reject the molded products after the interruption by the number set in the number of rejects after molding interruption 1833. The rejection after the interruption of the molding is not limited to the case where the user interrupts the injection molding, and may include the case where the injection molding is interrupted according to the determination result as to whether the defect (abnormality) of the molded product being occurred.

In the present embodiment, the control device 700 includes the above-described configuration, and thus can perform abnormality determination based on the quality characteristics output from the trained model LM and can perform processing when the abnormality being determined.

In the present embodiment, the waveform data input to the trained model LM can be monitored by the quality characteristics output from the trained model LM.

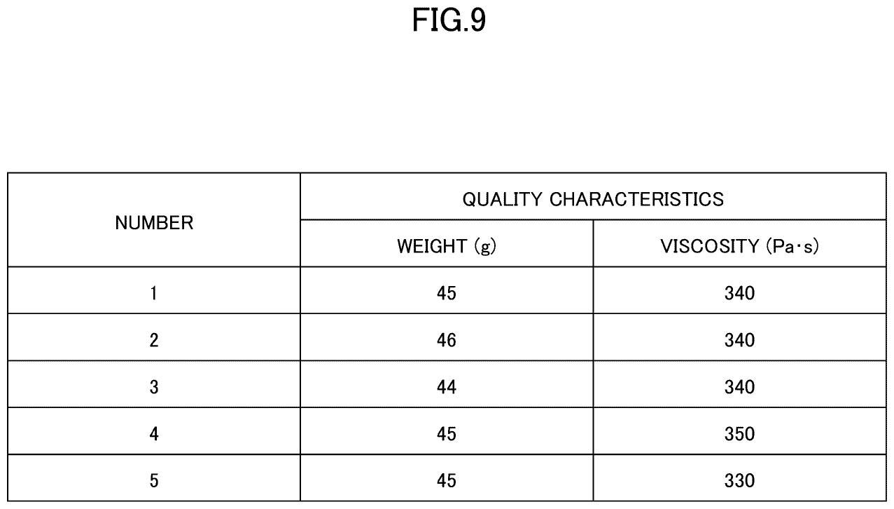

FIG. 9 is a diagram illustrating the quality characteristics output from the trained model LM according to the present embodiment. In the example illustrated in FIG. 9, two quality characteristics (weight and viscosity) output from the trained model LM are illustrated for each (shot) number.

In the example illustrated in FIG. 9, the user can recognize the state of the molded product or the molding material by referring to the weight and the viscosity for each (shot) number.

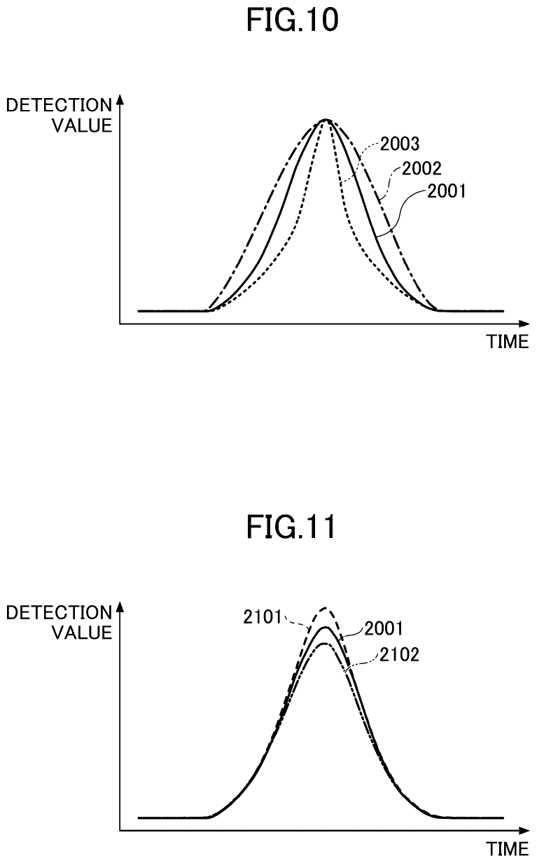

FIGS. 10 and 11 are diagrams illustrating waveform data for each (shot) number illustrated in FIG. 9, which is detected when a molded product is molded by the injection molding machine 10 according to the embodiment. In the examples illustrated in FIGS. 10 and 11, the vertical axis represents the detection value, and the horizontal axis represents time. The detection values detected as the waveform data in FIGS. 10 and 11 may be detection results of any sensors provided in the injection molding machine 10.

The waveform data 2001, the waveform data 2002, and the waveform data 2003 illustrated in FIG. 10 correspond to the (shot) number “1”, the number “2”, and the number “3” in FIG. 9.

The waveform data 2001, the waveform data 2101, and the waveform data 2102 illustrated in FIG. 11 correspond to the (shot) number “1”, the number “4”, and the number “5” in FIG. 9.

That is, when the user refers to the waveform data 2001 to 2003, the user can grasp that the difference in the weight, in other words, a difference in the quality characteristics of the molded product by grasping the difference between the waveform data 2001 to 2003. However, unless the user is a skilled engineer, it is difficult to grasp the difference between the waveform data 2001 to 2003.

Similarly, when the user refers to the waveform data 2001, 2101, and 2102, the user can grasp a difference in viscosity, in other words, a difference in quality characteristics of the molding material by grasping a difference between the waveform data 2001, 2101, and 2102. However, unless the user is a skilled engineer, it is difficult to grasp the differences between the waveform data 2001, 2101, and 2102.

That is, the user can recognize whether an abnormality of the molded product or the molding material occurs by monitoring the waveform data, but a technique is required to recognize the abnormality. Further, when an abnormality has occurred in the molded product or the molding material, the abnormality has occurred as a difference in the shape of the waveform data. Therefore, it may be assumed that the user sets a threshold for the waveform data in order to detect an abnormality. However, in many cases, the user cannot grasp the difference in the shape of the waveform data between the case where an abnormality has occurred in the molded product and the case where abnormality has not occurred. Therefore, it is often difficult for the user to set a threshold or the like for the waveform data.

Therefore, in the present embodiment, the waveform data is input to the trained model LM, and the trained model LM performs inference.

That is, the control device 700 according to the present embodiment outputs the characteristics generated in the waveform data as the quality characteristics of the molded product, the molding material, or the like. The user can recognize the characteristics of the waveform data by referring to the output quality characteristics. In other words, the user can recognize an abnormality based on the waveform data.

The criteria for determining whether a molded product or the like is defective are often changed as necessary. In contrast, in the present embodiment, the trained model LM outputs quantitative data as the quality characteristics of the molded product, the molding material, or the like. Therefore, the threshold used for the abnormality determination by the determining unit 715 is also a numerical value. Therefore, the user can adjust the determination criteria by adjusting the numerical value of the threshold as illustrated in FIG. 6 and the like. That is, the control device 700 according to the present embodiment can provide flexibility to the determination criteria for determining whether the molded product or the like is defective.

In the present embodiment, an example in which the trained model LM is generated by the control device 700 has been described. However, the trained model LM according to the present embodiment is not limited to being generated by the control device 700. The trained model LM generated by another information processing device may be mounted on the control device 700.

In the present embodiment, the case of the value representing the evaluation of the product by the quantitative data has been described. However, in the present embodiment, the evaluation of the product is not limited to the quantitative data, and any parameter may be used as a reference for abnormality determination. A classification model in which numerical values for evaluating products are divided into sections may be used.

### Another Embodiment

In the example of the above-described embodiment, the highly accurate inference is performed by limiting the molding material (for example, to one type) for molding the molded product in the injection molding machine 10, and the inference is performed using the molding material. That is, in order to accurately infer the weight or the like of the molded product, information on the unique attribute of the molding material is required, and thus the injection molding machine 10 prepares a trained model corresponding to the molding condition. However, the above-described embodiment is not limited to the example of using a method of preparing the trained model corresponding to the molding conditions in order to infer the quality characteristics of the molded product. Thus, the present embodiment will illustrate a case in which a trained model capable of outputting quality characteristics is generated when waveform data is input, regardless of molding conditions, including a molding material.

The present embodiment is capable of using the trained model regardless of the molding material used for the molded product, the type of the mold device 800, and the molding conditions. That is, the trained model generated by the learning device may be mounted on each of the plurality of injection molding machines. Therefore, the present embodiment illustrates an example in which a learning device and a control device are provided.

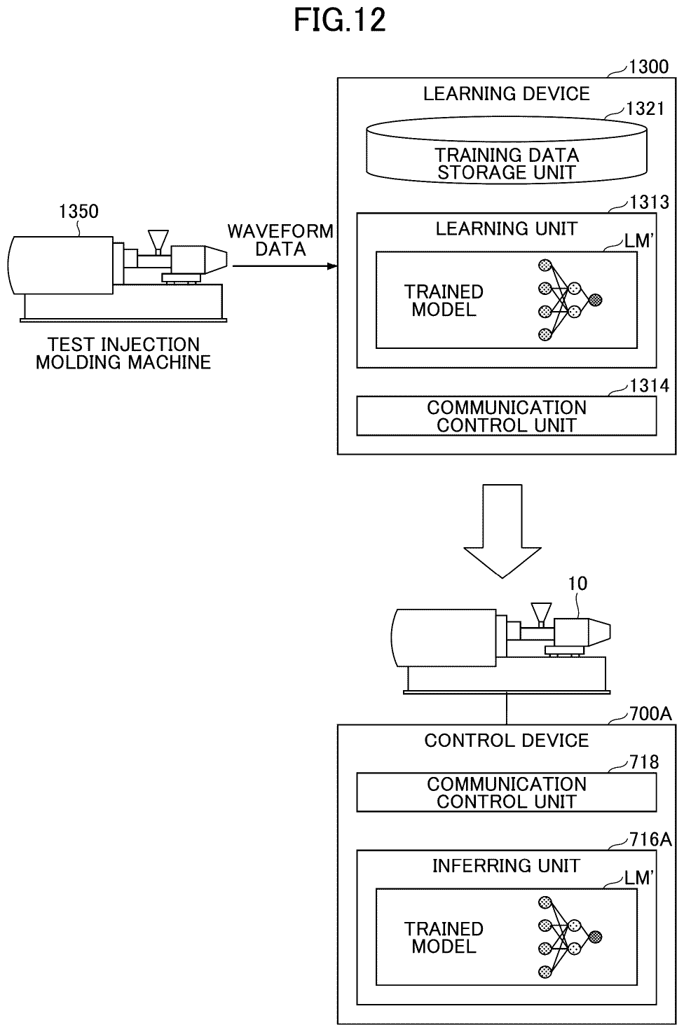

FIG. 12 is a conceptual diagram illustrating a linkage related to a trained model by the learning device and the control device of the injection molding machine according to the present embodiment.

In the example illustrated in FIG. 12, a test injection molding machine 1350, a learning device 1300, and a control device 700A of the injection-molding machine 10 are illustrated. In the present embodiment, an example is described in which a trained model LM′ having a configuration different from that of the trained model LM of the above-described embodiment is used. The configuration of the trained model LM′ will be described later.

In the example illustrated in FIG. 12, the test injection molding machine 1350 and the learning device 1300 may be owned by, for example, the producer of the injection molding machine 10, but the present disclosure is not limited to the example in which the test injection molding machine 1350 and the learning device 1300 is owned by the producer of the injection molding machine. For example, the test injection molding machine 1350 and the learning device 1300 may be owned by the shipment destination of the injection molding machine or may be owned by a service provider that generates a trained model. The injection molding machine 10 and the control device 700A illustrated in FIG. 12 may indicate a state before shipment, for example.

The test injection molding machine 1350 is an injection molding machine for performing machine learning. The configuration of the test injection molding machine 1350 is the same as that of the injection molding machine 10, and thus the description thereof will be omitted.

The test injection molding machine 1350 according to the present embodiment produces a molded product (an example of a product) in accordance with the setting by the user. Then, the test injection molding machine 1350 outputs, to the learning device 1300, waveform data measured while injection molding is performed. In the present embodiment, data indicating the detection results of the sensors provided in the test injection molding machine 1350 or the injection molding machine 10 in a time series is referred to as waveform data.

The learning device 1300 generates training data based on the input waveform data and stores the training data in the training data storage unit 1321.

In order to utilize artificial intelligence, it is necessary to execute a training phase and an inference phase.

The learning device 1300 executes a learning phase. For this purpose, the learning unit 1313 of the learning device 1300 causes the neural network to read the training data stored in the training data storage unit 1321, and generates a network in which the weighting and bias of the synapses are adjusted as the trained model LM′.

For example, the learning device 1300 reads a large amount of training data and performs machine learning by back propagation using a neural network to generate the trained model LM′.

The learning device 1300 may be, for example, an on-premise server installed in a factory or the like, or may be a cloud server. Furthermore, the learning device 1300 may be a stationary terminal device or a portable terminal device (portable terminal) that is disposed in a factory or the like. The stationary terminal device may include, for example, a desktop personal computer (PC). The portable terminal device may include, for example, a smartphone, a tablet terminal, a laptop PC, and the like.

The control device 700A of the injection molding machine 10 executes the inference phase. The control device 700A inputs the information to the trained model LM′ and causes the trained model LM′ to perform inference. Then, the control device 700A performs setting for a predetermined item of the forming condition based on the outputted result from the trained model LM′.

In the present embodiment, the structure of the trained model LM′ generated by the learning unit 1313 of the learning device 1300 and the structure of the trained model LM′ used by an inferring unit 716A of the control device 700A may be made the same. Then, the learning device 1300 may transfer the weights and biases of the trained model LM′ to the control device 700A. The control device 700A updates the trained model LM′ based on the received weights and biases, and thus the updated trained model LM′ can match the trained model LM′ of the learning unit 1313 in the learning device 1300. Thus, the learning unit 1313 of the learning device 1300 and the inferring unit 716A of the control device 700A in the injection molding machine 10 can be implemented in different languages. For example, the learning unit 1313 of the learning device 1300 may be implemented using Python, for example. On the other hand, the inferring unit 716A of the control device 700A may be implemented using, for example, C++.

Furthermore, the learning device 1300 and the control device 700A may be different in, for example, CPUs, OSs, development languages, and the like. The control device 700A can be a processor having a lower processing speed than that of the learning device 1300. This can achieve cost reduction.

For example, the weight and bias structure information to be transferred may include the value of each weight, the value of each bias, and the parameter structure information, and may be, for example, an object that describes the value of each weight and the value of each bias according to the data structure using a predetermined method (e.g., JSON (JavaScript Object Notation), XML (Extensible Markup Language), ONNX (Open Neural Network Exchange), etc.). Extensible Markup Language), etc.) according to the data structure.

Accordingly, the learning device 1300 can transfer information indicating the structure of the weights and biases to the control device 700A of the injection molding machine 10.

The present embodiment is not limited to the method of transferring the information indicating the structure of the weights and biases from the learning device 1300 to the injection molding machine 10, and the trained model LM′ itself may be transferred from the learning device 1300 to the control device 700A of the injection molding machine 10. In this case, the CPUs, the OSs, the development languages, and the like may be matched between the control device 700A and the learning device 1300.

Accordingly, the control device 700A can perform inference using the trained model LM′ generated in the learning phase of the learning device 1300. Next, a configuration of the trained model LM′ will be described.

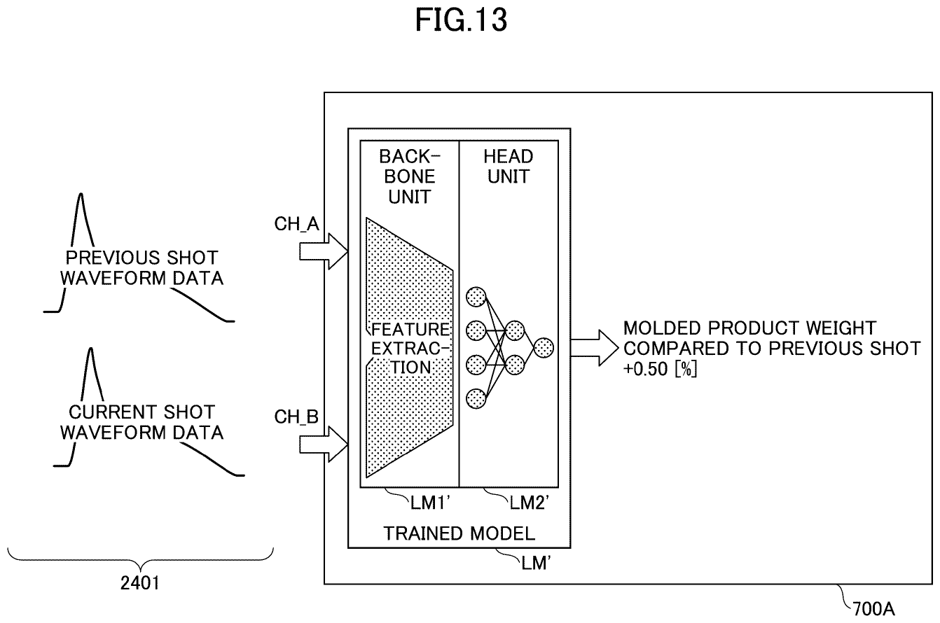

FIG. 13 is a conceptual diagram illustrating the structure of the trained model LM′ according to the present embodiment. As illustrated in FIG. 13, the trained model LM′ according to the present embodiment includes a backbone unit LM1′ and a head unit LM2′.

The trained model LM′ according to the present embodiment has two channels (CH_A and CH_B), and waveform data 2401 of different shots are input to the two channels, respectively.

The input layer of the trained model LM′ is configured to input waveform data of the previous shot to the channel CH_A and input waveform data of the current shot to the channel CH_B, for example.

The backbone unit LM1′ is a neural network for extracting features from two or more input waveform datasets. The training method is the same as that in the above-described embodiment, and a description thereof will be omitted.

The backbone unit LM1′ extracts respective features from the waveform data of the previous shot input to the channel CH_A and the waveform data of the current shot input to the channel CH_B.

The head unit LM2′ outputs the output data representing the difference in quality characteristics between the molded product molded in the previous shot and the molded product molded in the current shot, based on the features extracted from each of the two or more waveform datasets. In the example illustrated in FIG. 5, the ratio of the weight of the molded product of the current shot to the weight of the molded product of the previous shot is output. In the example illustrated in FIG. 5, the weight of the molded product of the current shot is increased by 0.50% compared to the molded product of the previous shot.

That is, the trained model LM′ according to the present embodiment extracts features from a difference between waveform data of two or more different shots, and outputs a difference in quality characteristics of a molded product between the shots. The trained model LM′ performs inference based on a difference between two or more pieces of waveform data, and thus can be used regardless of the molding material, the mold device 800, the molding conditions, and the like.

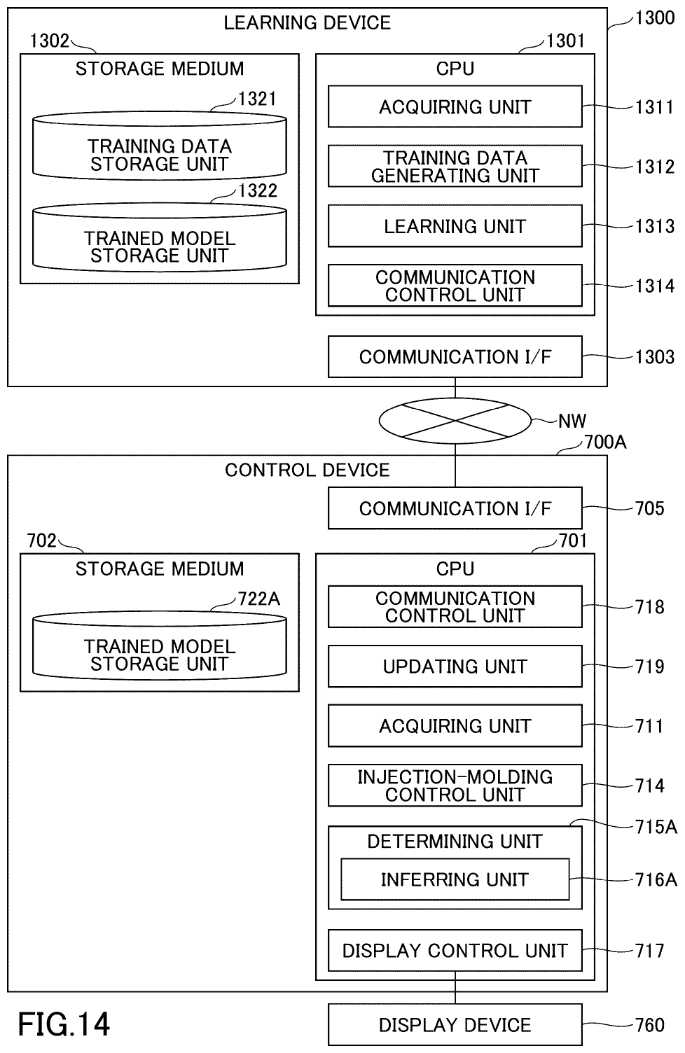

FIG. 14 is a diagram illustrating an example of a functional configuration of the learning device 1300 and the control device 700A according to the present embodiment. As illustrated in FIG. 14, the learning device 1300 and the control device 700A are connected to each other via a communication line NW.

The functions of the learning device 1300 are implemented by any given hardware, a combination of any given hardware and software, or the like. For example, as illustrated in FIG. 14, the learning device 1300 includes a CPU 1301, a storage medium 1302, and a communication interface 1303.

The storage medium 1302 stores various installed programs, and also stores files, data, and the like necessary for various processes. The storage medium 1302 includes, for example, a hard disk drive (HDD), a solid state drive (SSD), a flash memory, or the like.

The storage medium 1302 according to the present embodiment includes a training data storage unit 1321 and a trained model storage unit 1322.

The training data storage unit 1321 stores training data used for training of the trained model LM′. The configuration of the training data will be described later.

The trained model storage unit 1322 stores the trained model LM′.

The communication I/F 1303 is used as an interface for connecting to an external device so as to be able to communicate with the external device. Thus, the learning device 1300 can communicate with an external device such as the injection molding machine 10 through the communication I/F 1303. The communication I/F 1303 may include a plurality of types of communication interfaces depending on a communication method with a device to be connected.

The CPU 1301 of the learning device 1300 executes the program stored in the storage medium 1302. Accordingly, the CPU 1301 includes an acquiring unit 1311, a training data generating unit 1312, a a learning unit 1313, and communication control unit 1314 as functional units.

The acquiring unit 1311 acquires waveform data (an example of first data) from the test injection molding machine 1350 representing the detection results by the sensors in the test injection molding machine 1350 every time injection molding is performed. In the present embodiment, the acquiring unit 1311 acquires waveform data from the start to the end of the molding cycle of the test injection molding machine 1350. The type of waveform data to be acquired is the same as that in the above-described embodiment, and thus the description thereof will be omitted.

The acquiring unit 1311 acquires the quality characteristics of the molded product of the injection molding machine by the test injection molding machine 1350.

Further, the quality characteristics output from the trained model LM′ may be normalized. For example, the quality characteristics output from the trained model LM′ may be adjusted so that a numerical value between 0.0 to 1.0 is output. Standardization may also be performed on quality characteristics.

The training data generating unit 1312 generates, for each (shot) number, training data by combining the waveform data of the (n−1)^{th} shot, the waveform data of the n^{th} shot, and the difference in quality characteristics (for example, an increase or a decrease in weight, or an increase or a decrease in viscosity) between the molded product molded in the (n−1)^{th} shot and the molded product molded in the n^{th} shot acquired by the acquiring unit 1311. Then, the training data generating unit 1312 stores the generated training data in the training data storage unit 1321. Note that n is a natural number of 2 or more.

The present embodiment illustrates an example of a method of generating the training data, but the training data may be generated using methods other than the method described above. In addition, the present embodiment is not limited to the method in which the learning device 1300 automatically performs all the processes up to the generation of the trained model LM′. For example, after the learning device 1300 generates a plurality of training data, the user may check a content included in each of the plurality of training data.

In the present embodiment, the plurality of training data may be referred to as a training dataset. The training dataset is a set of training data obtained by combining waveform data as an input and a value as quantitative data representing quality characteristics of a molded product or a molding material as an output.

Then, after the user completes the checking, correction, and the like of the content included in the training dataset, the learning device 1300 may generate the trained model LM′ based on the training dataset.

The learning unit 1313 generates the trained model LM′ by performing machine learning based on the training dataset stored in the training data storage unit 1321. The trained model LM′ is generated by applying supervised learning to the base learning model. As a modification, there is also a method of using transfer learning to generate the trained model LM′. In a case where the trained model LM′ is generated using the transfer learning, for example, a training method of using unsupervised learning for the backbone unit LM1′ and using supervised learning for the head unit LM2′ may be used.

Specifically, the learning unit 1313 generates the trained model LM′ by performing machine learning based on the waveform data of the first shot (an example of the third cycle), the waveform data of the second shot (an example of the fourth cycle), and a value (an example of the second value) indicating a difference in quality characteristics between the molded product produced in the first shot and the molded product produced in the second shot by quantitative data, which are included in the training dataset.

When waveform data of the previous shot and waveform data of the current shot detected while the injection molding machine 10 or the test injection molding machine 1350 performs molding are input from the input layer, the trained model LM′ outputs, from the output layer, a difference in quality characteristics between a molded product produced by the previous shot and a molded product produced by the current shot.

In addition, the trained model LM′ may be updated by additionally training the existing trained model LM′ with a new training dataset.

As the machine learning used for generating the trained model LM′, for example, a neural network may be applied, and as a more specific example, deep learning may be applied. As an algorithm of the deep learning, a deep neural network (DNN), a convolutional neural network (CNN), or a recurrent neural network (RNN) may be applied. Furthermore, a long short term memory (LSTM) or a transformer may be applied.

The communication control unit 1314 transmits and receives information to and from an external device such as the injection molding machine 10 using the communication I/F 1303. For example, the communication control unit 1314 may transmit the trained model LM′ stored in the trained model storage unit 1322 to the control device 700A of the injection molding machine 10. The communication control unit 1314 may extract a structure indicating parameters (for example, a weight and a bias) set in each layer forming the trained model LM′ stored in the trained model storage unit 1322 and transmit the structure to the control device 700A.

FIG. 14 illustrates the components of the control device 700A of the injection molding machine 10 in the form of functional blocks. Each functional block illustrated in FIG. 14 is conceptual, and is not necessarily physically configured as illustrated in the figure. All or some of the functional blocks may be configured to be functionally or physically distributed or integrated in any given units. All or some of the processing functions performed by the functional blocks are implemented by a program executed in the CPU 701. Alternatively, each functional block may be implemented as hardware by wired logic. As illustrated in FIG. 14, the CPU 701 of the control device 700A includes a communication control unit 718, an updating unit 719, an acquiring unit 711, an injection-molding control unit 714, a determining unit 716A including an inferring unit 715A, and a display control unit 717. The control device 700A includes a trained model storage unit 722A in the storage medium 702.

The trained model storage unit 722A stores the trained model LM′. The configuration of each layer of the trained model LM′ is the same as that of the trained model LM′ stored in the trained model storage unit 1322 of the learning device 1300.

The communication control unit 718 transmits and receives information to and from an external device such as the learning device 1300 using the communication I/F 705. For example, the communication control unit 718 may receive the trained model LM′ from the learning device 1300. The communication control unit 718 may receive information indicating a structure indicating parameters (for example, a weight and a bias) set in each layer forming the trained model LM′.

The updating unit 719 updates the trained model LM′ stored in the trained model storage unit 722A with the received trained model LM′ or the information indicating the structure. Accordingly, the updating unit 719 can match the trained model LM′ stored in the trained model storage unit 722A with the trained model LM′ of the learning device 1300.

In a case where the updating is performed with information indicating a structure indicating parameters (for example, a weight and a bias) set in each layer forming the trained model LM′, the updating unit 719 may be configured as a program for updating the trained model LM′. The updating unit 719 may determine whether the number of layers and the number of nodes for each layer defined between the trained model LM′ stored in the trained model storage unit 722A and the received information indicating the structure match. Then, when the updating unit 719 determines that the two pieces of information match, the updating unit 719 updates the trained model LM′. When the updating unit 719 determines that the structures do not match, the updating unit 719 may output an alert screen indicating that the structures are different to the display device 760 or the like without updating the trained model LM′.

The injection-molding control unit 714 executes a process for producing a molded product by the injection molding machine 10. For example, the injection-molding control unit 714 may perform injection molding after setting each item configuring a molding condition when producing a molded product.

The determining unit 715A includes the inferring unit 716A, and determines whether an abnormality (defect) has occurred in the molded product based on the information acquired from the inferring unit 716A.

The inferring unit 716A inputs the waveform data of the previous shot (example of the first molding cycle) and the waveform data of the current shot (example of the second molding cycle) detected by the various sensors while the injection-molding control unit 714 produces the molded product to the input layer of the trained model LM′.

The inferring unit 716A may perform preprocessing on the waveform before inputting the waveform to the input layer.

The determining unit 715A determines whether an abnormality has occurred based on the weight (an example of the quality) of the molded product received from the inferring unit 716A. The criteria for determining whether an abnormality has occurred may be set by the user. For example, the determining unit 715A may determine that an abnormality has occurred when the amount of increase or decrease in weight from the previous time is equal to or greater than a predetermined reference (for example, a change of 0.4% or more).

The display control unit 717 displays information on the display device 760. For example, the display control unit 717 may display the determination results of the determining unit 715A in the record list of the log information screen. The display method of the determination results may be any method, and may be the same display mode as that in the embodiment.

In the present embodiment, the case where the waveform data of the previous shot is input to the channel CH_A of the input layer and the waveform data of the current shot is input to the channel CH_B of the input layer has been described. However, the correspondence relationship between the channels of the input layer and the waveform data to be input is not limited to the case in the present embodiment, and the correspondence relationship may be designed by any method. Further, the present disclosure is not limited to the method of providing channels corresponding to waveform data in order to input a plurality of waveform data, and a plurality of waveform data may be input to the input layer in a flat manner.

In the present embodiment, an example has been described in which whether an abnormality has occurred is determined based on the amount of change from the previous shot, based on the waveform data of the previous shot and the waveform data of the current shot. However, the present embodiment is not limited to the method of determining whether an abnormality has occurred based on the amount of change from the previous shot. For example, the user may select waveform data of a reference shot. In this case, the waveform data of the shot selected by the user (the reference) is input to the channel CH_A of the input layer in the trained model LM′ and the waveform data of the current shot is input to channel CH_B of the input layer. Then, the trained model LM′ outputs the amount of change in the quality characteristics of the molded product with respect to the reference shot from the output layer. Thus, it is possible to determine whether the molded product is abnormal based on the difference from the molded product acting as a reference.

In the present embodiment, an example in which waveform data of two shots is input has been described. However, the present embodiment is not limited to the example in which the waveform data of two shots is input. The inferring unit 716A may input waveform data of three or more shots to the trained model LM′ and receive differences in quality characteristics among three or more molded products. Then, the determining unit 715A may perform the abnormality determination based on the difference in the qualitative characteristics output from the trained model LM′.

Note that the present embodiment is not limited to the method of learning performed only by the learning device 1300, and additional training or the like may be provided in the trained model LM′ stored in the control device 700A of the injection molding machine 10.

In the above-described embodiment, an example in which the abnormality (defect) of the molded product is determined using the trained models LM and LM′ mounted on the injection molding machine 10 has been described. However, the above-described embodiment is not limited to the example using a method of determining the abnormality (defect) of the molded product by the injection molding machine 10.

### (Modification)

In the above-described embodiments, the example in which the control device 700 or 700A of the injection molding machine 10 performs the abnormality determination using the trained model as the monitoring device of the injection molding machine 10 has been described. However, the above-described embodiment is not limited to the example in which the control device 700 or 700A of the injection molding machine 10 performs the abnormality determination using the trained model. Accordingly, in a modification, a group management device that controls the injection molding machine 10 may determine an abnormality of a molded product produced by the injection molding machine 10.

For example, the group management device manages the plurality of injection molding machines 10. The storage device of the group management device is provided with a trained model storage unit 722 or the trained model storage unit 722A. Further, the CPUs of the above-described embodiments are provided with the determining unit 715 or the determining unit 715A. Then, the group management device receives waveform data from the plurality of injection molding machines 10, and determines abnormality of the molded product based on the received waveform data by the same method as that of the above-described embodiments.

The group management device may perform processing based on the result of the abnormality determination, as in the above-described embodiment. For example, the group management device may display the determination result of the abnormality. As another example, the group management device may instruct the injection molding machine 10 to stop or the like when that an abnormality has occurred is determined.

### <Operation>

In the above-described embodiments and modifications, when waveform data is input to the input layer of the trained model LM or LM′, a value representing the evaluation of a molded product as quantitative data is acquired, and it is determined whether abnormality has occurred based on the acquired value. Therefore, when monitoring the waveform data, it is easy to intuitively grasp whether an abnormality has occurred by monitoring the quality characteristics that change in accordance with the waveform data, rather than the waveform data itself.

That is, when monitoring waveform data, basic statistics such as the largest value, the smallest value, and the mean of the waveform data or the accumulated value is monitored. However, it is difficult for the user to identify what kind of reference to the statistic or the accumulated value of the waveform data should be set in order to detect the presence or absence of the abnormality of the quality. In contrast, in the above-described embodiment and modification, when waveform data is input to the trained model, the presence or absence of abnormality is detected based on a value indicating the quality characteristic of the molded product output from the trained model by quantitative data. Therefore, the user can easily and intuitively grasp the criteria for determining an abnormality.

In the above-described embodiment, the waveform data is input to the trained model, and it is determined whether the molded product or the like is abnormal based on the quality characteristics of the molded product or the like output from the trained model. That is, the trained model outputs a result obtained by considering various features included in the waveform data as the quality characteristics of the molded product or the like. Therefore, the abnormality determination based on the quality characteristics of the molded product or the like can be regarded as a determination based on the results of various studies (understanding) on the waveform data. Therefore, the above-described embodiment enables abnormality determination in consideration of complex features included in waveform data.

In the above-described embodiments, since the trained model obtained by machine learning is used as training data in which wave form data and quality characteristics of a molded product or the like are associated with each other, the user can recognize whether abnormality has occurred in the waveform data by referring to the quality characteristics even when the user does not recognize the correspondence relationship between the waveform data and the quality characteristics. In other words, it is possible to determine an abnormality based on the correspondence relationship between the quality characteristics and the change in the waveform data, which is difficult for the user to grasp.

Furthermore, changing the criteria for determining whether an abnormality has occurred, it is sufficient to adjust the threshold (numerical value) for the quality characteristics represented by the quantitative data, and therefore flexible adjustment is possible in accordance with the quality of the molded product and the like. Therefore, since flexible adjustment can be performed when abnormality determination is performed, the accuracy in abnormality determination is improved.

Although the monitoring device for an injection molding machine according to the embodiments of the present disclosure has been described above, the present disclosure is not limited to the above-described embodiments and the like. Various changes, modifications, substitutions, additions, deletions, and combinations are possible within the scope of the claims. Such modifications are also included in the technical scope of the present disclosure.

What is claimed is:

1. A monitoring device for an injection molding machine, the monitoring device comprising:
circuitry configured to
acquire first data from a sensor provided in an injection molding machine, the first data indicating detection results in a time series;
input the first data into a trained model and acquire a first value from the trained model, the first value representing an evaluation of a product, the trained model being trained by machine learning with training data, the training data combining second data and a second value, the second data indicating detection results from the sensor in a time series, and the second value representing an evaluation of the product produced by the injection molding machine; and
determine whether an abnormality has occurred in the detection results of the sensor, based on the acquired first value by the inferring unit.

2. The monitoring device for an injection molding machine according to claim 1, wherein
the first value and the second value are each quantitative data.

3. The monitoring device for an injection molding machine according to claim 2, wherein
the circuitry determines whether an abnormality has occurred in the detection results of the sensor, based on whether the first value is larger than a predetermined threshold.

4. The monitoring device for an injection molding machine according to claim 3, wherein
the predetermined threshold used for the determination by the circuitry is set based on a measurement unit of a determination target.

5. The monitoring device for an injection molding machine according to claim 2, wherein the circuitry
acquires the first data in a first molding cycle of the injection molding machine and subsequently acquires the first data in a second molding cycle of the injection molding machine, and
inputs the first data of each of the first molding cycle and the second molding cycle into the trained model and acquires the first value, the first value representing a difference in evaluation between the product of the first molding cycle and the product of the second molding cycle as quantitative data, the trained model being trained by machine learning with training data, the training data combining the second data in a third cycle, the second data in a fourth cycle, and the second value, and the second value representing a difference in evaluation between the product in the third cycle and the product in the fourth cycle as quantitative data.

6. The monitoring device for an injection molding machine according to claim 1, wherein the circuitry is further configured to
display, on a display device, one or more of determination results of the product by the circuitry or the first value, every time the product is produced by the injection molding machine.
